(19) United States
(12) Patent Application Publication
(10) Pub. No.: US 2026/0245273 A1
(43) Pub. Date: Aug. 20, 2026

(54) GENERATING IN-APP STARTER ELEMENTS FOR THEME-BASED DIGITAL IMAGE EDITING UTILIZING GENERATIVE NEURAL NETWORKS

(71) Applicant: Adobe Inc., San Jose, CA (US)

(72) Inventors: Tapan Agarwal, Meerut (IN); Rohit Kumar Guglani, Noida (IN); Karan Batra, Shamli (IN); Abhishek Aggarwal, New Delhi (IN)

(21) Appl. No.: 19/057,192

(22) Filed: Feb. 19, 2025

(51) Int. Cl. G06T 11/60; G06F 3/0482; G06F 3/04845; G06T 7/12; G06V 10/82

(52) U.S. Cl. CPC G06T 11/60; G06F 3/0482; G06F 3/04845; G06T 7/12; G06V 10/82; G06T 2207/20132

(57) ABSTRACT

The present disclosure relates to systems, non-transitory computer-readable media, and methods for generating one or more interactive object elements consistent with a determined theme using a large language model in combination with an image generation neural network. For example, the disclosed systems determine, from a text input via a graphical user interface, a theme for inserting image content into a digital image within the graphical user interface. The disclosed systems generate, in response to the text input, a prompt indicating one or more objects related to the theme. The disclosed systems generate, by utilizing an image generation neural network, one or more object elements corresponding to the one or more objects related to the theme for display within the graphical user interface. In various embodiments, the disclosed systems provide the one or more object elements as one or more interactive object elements for inserting into the digital image.

### BACKGROUND

Generating and utilizing graphic elements are fundamental tasks in graphic design. Ensuring that individual graphical elements have consistent visual and thematic relationships to other content in digital designs is often a challenging task. Recent years have seen significant advancements in tools that aid in generating thematic reference images or templates in digital images. These tools range from stock image platform utilization to generative AI systems that produce images from text prompts. While these existing systems offer limited capabilities for generating graphic elements for use in various digital design environments, these conventional systems continue to suffer from a number of disadvantages.

### SUMMARY

One or more embodiments described herein provide benefits and/or solve one or more of the foregoing or other problems in the art with systems, methods, and non-transitory computer-readable media for generating one or more elements that are stylistically consistent based on a given theme. To illustrate, the disclosed systems provide, to a large language model, a large language model prompt that is engineered to guide a large language model to generate a list of distinct objects representative of a theme as designated by a user input. Specifically, the disclosed systems determine the theme from a user input designating a theme to guide the generation of one or more thematic elements. In some embodiments, the disclosed systems additionally generate one or more digital elements by engineering a diffusion service prompt to provide to an image generation neural network to generate an intermediate digital image including one or more digital elements based on the list of distinct objects representative of the theme. In one or more embodiments, the disclosed systems further introduce processes for segmenting the digital image into individual digital elements for use in a digital image (e.g., for individual selection and insertion into the digital image via a graphical user interface).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a schematic diagram of an example system environment for implementing a thematic element system in accordance with one or more embodiments.

FIG. 2 illustrates an overview diagram of the thematic element system generating one or more interactive object elements based on user input indicating a theme in accordance with one or more embodiments.

FIG. 3 illustrates a diagram of the thematic element system generating one or more interactive object elements based on a text prompt in accordance with one or more embodiments.

FIG. 4 illustrates a diagram of the thematic element system generating a single interactive object element in accordance with one or more embodiments.

FIG. 5 illustrates a diagram of the thematic element system generating multiple interactive object elements in accordance with one or more embodiments.

FIG. 6 illustrates a diagram of the thematic element system utilizing a reference image in generating an intermediate digital image in accordance with one or more embodiments.

FIGS. 7A-7B illustrate diagrams of the segmentation neural network of the thematic element system isolating digital elements within an intermediate digital image in accordance with one or more embodiments.

FIG. 8 illustrates the thematic element system generating sets of object elements in accordance with one or more embodiments.

FIG. 9A-9B illustrate an example of the thematic element system providing interactive object elements in a digital image in accordance with one or more embodiments.

FIG. 10 illustrates a schematic diagram of the thematic element system in accordance with one or more embodiments.

FIG. 11 illustrates a flowchart of a series of acts for generating a one or more thematic elements by utilizing a user input indicating a theme in combination with a diffusion model in accordance with one or more embodiments.

FIG. 12 shows an example of a guided diffusion model according to aspects of the present disclosure.

FIG. 13 shows an example of a U-Net according to aspects of the present disclosure.

FIG. 14 shows an example of a method for conditional media generation according to aspects of the present disclosure.

FIG. 15 shows a diffusion process according to aspects of the present disclosure.

FIG. 16 shows a flow diagram depicting an algorithm as a step-by-step procedure for training a machine-learning model according to aspects of the present disclosure.

FIG. 17 shows an example of a method for training a diffusion model according to aspects of the present disclosure.

FIG. 18 shows an example of a computing device according to aspects of the present disclosure.

FIG. 19 shows an example of a synthesized image generation apparatus according to aspects of the present disclosure.

FIG. 20 illustrates a block diagram of an example computing device for implementing one or more embodiments of the present disclosure.

### DETAILED DESCRIPTION

This disclosure describes one or more embodiments of a thematic element system that generates one or more interactive object elements consistent with a determined theme using a large language model (“LLM”) in combination with an image generation neural network (e.g., a diffusion model). In many use cases, graphic designers create or modify digital images or graphic designs by incorporating individual digital elements, many of which are intended to align with the overall style of the digital image or graphic design. To improve on existing approaches for creating thematic digital elements, in some embodiments, the thematic element system generates a set of digital elements by utilizing a multi-neural network pipeline to generate a list of distinct objects representative of a theme indicated by a user input and a set of interactive object elements corresponding to the list of distinct objects. In particular, the thematic element system utilizes an LLM to generate a list of objects related to the theme as indicated by a user input. Additionally, in some cases, the thematic element system employs an image generation neural network to generate an intermediate digital image that includes object elements based on the list of objects. Further, in one or more embodiments, the thematic element system utilizes a segmentation neural network that isolates the object elements from the intermediate digital image generated by the image generation neural network to provide interactive object elements for display and/or manipulation in a graphical user interface.

As described above, to generate a set of thematic digital elements, in some embodiments, the thematic element system utilizes a large language model to generate a list of objects relevant to a theme as indicated by a user input. In some cases, the thematic element system employs a text input source (e.g., single word, phrase, short description) to determine a theme which is used to guide an LLM in generating the list of objects. Accordingly, in some embodiments, the thematic element system generates an LLM prompt that instructs the LLM to generate of a list of a predetermined number of distinct objects that are representative of a theme as indicated in a user input (e.g., text input) source.

As just described, the thematic element system generates an intermediate digital image that contains theme-specific object elements by utilizing an image generation neural network. For instance, the thematic element system provides a prompt (e.g., a diffusion model prompt) to an image generation neural network, which generates an intermediate digital image that includes one or more object elements that are related to a specific theme. For example, the thematic element system generates a diffusion model prompt that includes one or more objects related to a theme to guide the diffusion model in creating an intermediate digital image including object elements optimized for further manipulation. In certain cases, the thematic element system utilizes a predefined reference image as a visual guide to influence the spatial arrangement and/or aesthetic consistency of the generated set of digital elements.

As mentioned previously, the thematic element system utilizes a segmentation neural network to isolate object elements within an intermediate digital image. For example, the thematic element system employs a segmentation neural network to create a digital mask of each object element. Accordingly, in some embodiments, the thematic element system utilizes the digital masks to segment the individual object elements from the intermediate digital image. Furthermore, in various cases, the thematic element system generates interactive object elements based on the segmented object elements. In various embodiments, the interactive object elements are provided to a graphical user interface for display and/or manipulation within a digital image.

As suggested above, many conventional systems exhibit a number of shortcomings or disadvantages, particularly in efficiently generating a set of digital elements according to a theme. To elaborate, some existing sources for sourcing visual content require a search across multiple platforms to access image content from different sources, requiring time and effort on the part of the conventional system as well as expertise and communication access on the part of the system(s) and/or user(s) of the system(s). Additionally, searches through databases such as stock image banks are often rigid in their sorting options, such that grouping images by a visual theme (e.g., color, style) is very difficult. Furthermore, many of these images are not ready for integration into a digital image and require post-processing (e.g., changing color, segmentation, or other manipulations) to allow insertion of the images and/or editing of the images in additional image content.

Due at least in part to their inefficiencies, many prior systems are also inaccurate. In generating multiple objects, conventional systems struggle to maintain a cohesive visual identity. For example, utilizing some conventional systems capable of generating individual elements results in disjointed designs and a lack of visual harmony between elements (e.g., different color schemes, varied lighting). Conventional systems that utilize categorical libraries or allow for single word inputs are also unable to capture thematic nuance that is often part of natural language descriptions of those themes.

In addition to problems of inefficiency and inaccuracy, conventional digital illustration systems also experience problems of operational inflexibility. Bringing in elements or objects from outside sources into a digital image results in outputs that often cannot be resized or adjusted without losing quality. Furthermore, many conventional systems also have a finite number of rigidly defined categories of available image content for use in generating or editing digital images. Indeed, these conventional systems often provide a single set of categories (e.g., via a rigid set of menus) from which a user selects elements to use in generating digital image content.

As suggested, one or more embodiments of the thematic element system provide several advantages over conventional image generation systems. For example, in one or more cases, the thematic element system improves computational efficiency and speed over current digital image generation systems. In contrast to conventional systems that use generative models to create new content in a plurality of separate generation steps and post-processing steps, the thematic element system generates thematic elements in a single step. Specifically, based on the input of a theme (single word, phrase, explanation) the thematic element system generates a number of elements that are most highly correlated with the theme. In some embodiments, the thematic element system generates a set of thematic digital elements that are similar in alignment, color, and/or topic automatically, removing the need for post-processing to stylistically modify the elements. Furthermore, in some cases, the thematic element system recalls user preferences and settings to skip repetitive configurations to align with the desired theme of a user, eliminating the need for iterative system adjustments. Thus, the thematic element system reduces or eliminates inefficient device interactions to facilitate manipulation of elements to align with a theme, providing faster, more efficient generation of a thematic set of digital illustration elements.

Relatedly, as mentioned, the thematic element system improves over inaccuracies of prior systems, particularly in generating a set of thematically-similar individual digital elements (e.g., interactive object elements). As discussed previously, in some embodiments, the thematic element system utilizes an LLM to find a discrete number of objects that most accurately represent the theme input by a user. By using a prompt based on the user input, in some cases, the LLM interprets phrases that more fully capture the theme than a single word. Additionally, by utilizing the diffusion model to generate a single image including a plurality of object elements, the thematic element system generates all elements with consistent visual characteristics. Furthermore, in one or more embodiments, by utilizing a reference image as a stylistic backdrop, each element is generated in a similar format, which provides for more accurate theme/style matching. Thus, in certain cases, the thematic element system accurately generates a set of elements that relate to a common theme, providing a stylistically-similar and thematically-relevant set of elements for use in a digital image.

Similarly, the thematic element system improves upon operational flexibility. In some embodiments, the thematic element system uses an input source to intelligently capture the nuances of a desired theme for a set of digital elements. With natural language processing capabilities, the number of themes (and elements) is potentially infinite. Additionally, the thematic element system, with its adaptive learning capabilities, tailors the output of elements based on past projects and preferences of a user. Furthermore, the thematic element system is scalable, as the thematic element system is capable of handling single element generation or entire libraries.

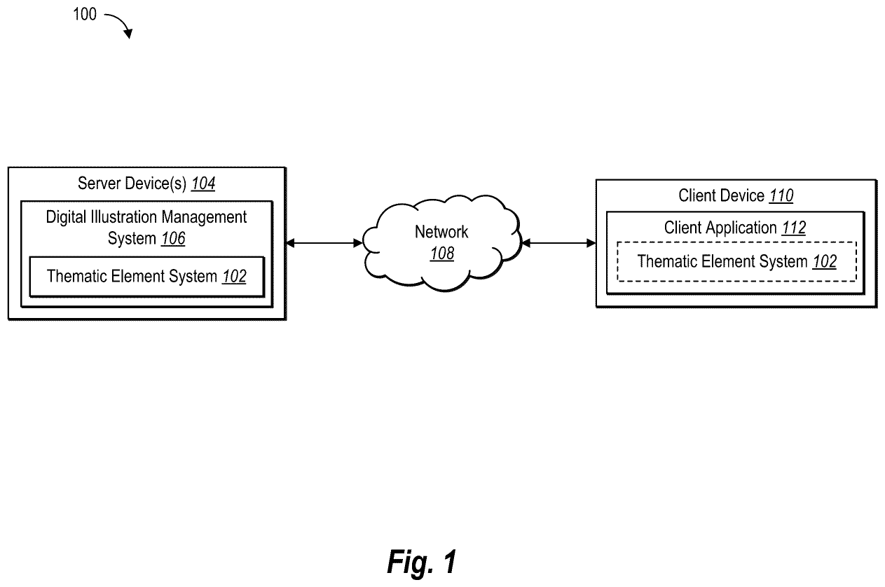

For example, FIG. 1 illustrates a schematic diagram of an exemplary system environment 100 in which a thematic element system 102 operates. As illustrated in FIG. 1, the system environment 100 includes server device(s) 104, a digital illustration management system 106, a thematic element system 102, a network 108, a client device 110, and a client application 112.

Although the system environment 100 of FIG. 1 is depicted as having a particular number of components, the system environment 100 is capable of having a different number of additional or alternative components (e.g., a different number of servers, client devices, or other components in communication with the thematic element system 102 via the network 108). Similarly, although FIG. 1 illustrates a particular arrangement of the server device(s) 104, the network 108, and the client device 110, various additional arrangements are possible.

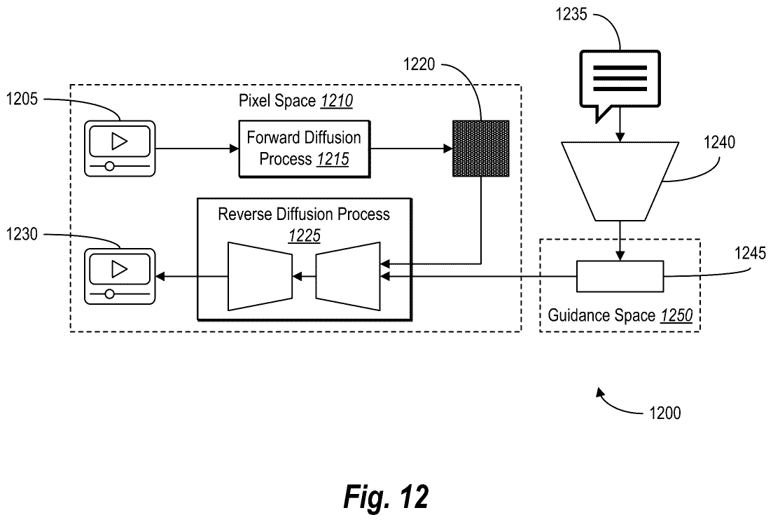

The server device(s) 104, the network 108, and the client device 110 are communicatively coupled with each other either directly or indirectly (e.g., through the network 108 discussed in greater detail below in relation to FIG. 12). Moreover, the server device(s) 104 and the client device 110 include one or more of a variety of computing devices (including one or more computing devices as discussed in greater detail in relation to FIG. 12).

As mentioned above, the system environment 100 includes the server device(s) 104. In one or more embodiments, the server device(s) 104 processes input to modify one or more objects within a client application (e.g., a digital illustration application for generating or editing digital images) from a user of the client application 112, such as by generating, inserting, and/or modifying graphical elements in digital images. In one or more embodiments, the server device(s) 104 comprises a data server. In some implementations, the server device(s) 104 comprises a communication server or a web-hosting server.

In one or more embodiments, the client device 110 includes a computing device that is able to provide, for display via the client application 112, entities within a digital image (e.g., a vector-based image or a raster-based image or a PDF file) such as objects, tools, user interface panels, or image elements on a graphical user interface of the client application 112. For example, the client device 110 includes smartphones, tablets, desktop computers, laptop computers, head-mounted-display devices, or other electronic devices. The client device 110 includes one or more applications (e.g., the client application 112) for modifying objects (e.g., generating or editing digital images) in accordance with the digital illustration management system 106. For example, in one or more embodiments, the client application 112 works in tandem with the thematic element system 102 to generate one or more interactive object elements consistent with a determined theme to provide via the client application 112. In particular, the client application 112 includes a software application installed on the client device 110. Additionally, or alternatively, the client application 112 of the client device 110 includes a software application hosted on the server device(s) 104 for access by the client device 110 through another application, such as a web browser.

To provide an example implementation, in some embodiments, the thematic element system 102 on the server device(s) 104 supports the thematic element system 102 on the client device 110. For instance, in some cases, the digital illustration management system 106 on the server device(s) 104 gathers data for the thematic element system 102. In response, the thematic element system 102, via the server device(s) 104, provides the information to the client device 110. In other words, the client device 110 obtains (e.g., downloads) the thematic element system 102 from the server device(s) 104. Once downloaded, the thematic element system 102 on the client device 110 generates one or more thematic interactive object elements for use in a digital image.

In alternative implementations, the thematic element system 102 includes a web hosting application that allows the client device 110 to interact with content and services hosted on the server device(s) 104. To illustrate, in one or more implementations, the client device 110 accesses a software application supported by the server device(s) 104. In response, the thematic element system 102 on the server device(s) 104 provides one or more interactive object elements to the client device 110 for display.

To illustrate, in some cases, the thematic element system 102 on the client device 110 receives text input via a graphical user interface indicating a theme. The client device 110 transmits the text input to the server device(s) 104. In response, the thematic element system 102 on the server device(s) 104 generates one or more interactive object elements to cause the client device 110 to display via the graphical user interface of the client application 112.

Indeed, in some embodiments, the thematic element system 102 is implemented in whole, or in part, by the individual elements of the system environment 100. For instance, although FIG. 1 illustrates the thematic element system 102 implemented or hosted on the server device(s) 104, different components of the thematic element system 102 are able to be implemented by a variety of devices within the system environment 100. For example, one or more (or all) components of the thematic element system 102 are implemented by a different computing device (e.g., the client device 110) or a separate server from the server device(s) 104. Indeed, as shown in FIG. 1, the client device 110 includes the thematic element system 102. Example components of the thematic element system 102 will be described below with regard to FIG. 12.

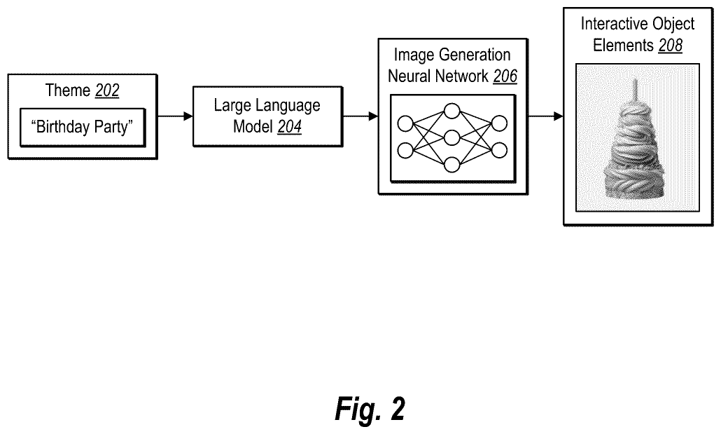

As mentioned above, in certain embodiments, the thematic element system 102 performs operations for generating one or more interactive object elements for display within a graphical user interface. FIG. 2 illustrates an overview diagram of the thematic element system generating one or more interactive object elements based on user input indicating a theme in accordance with one or more embodiments.

Indeed, as shown in FIG. 2, the thematic element system 102 detects a theme 202 according to a user input. The thematic element system 102, in some embodiments, receives or otherwise determines user input via text input (e.g. a single word, multiple words, a phrase, or other input) within a graphical user interface. In other embodiments, the thematic element system 102 alternatively (or additionally) receives user input via voice input, uploading an image, or URL input. In various cases, the thematic element system 102 detects a theme from the user input, with the theme capable of encompassing detailed and/or specific themes. The thematic element system 102, by interpreting essentially unlimited variations of themes, determines a theme 202 unrelated to a predefined catalogue of available topics. For example, as illustrated in FIG. 2, in response to a user inputting the text “birthday party” into a text box, the thematic element system 102 defines the theme as “birthday party.”

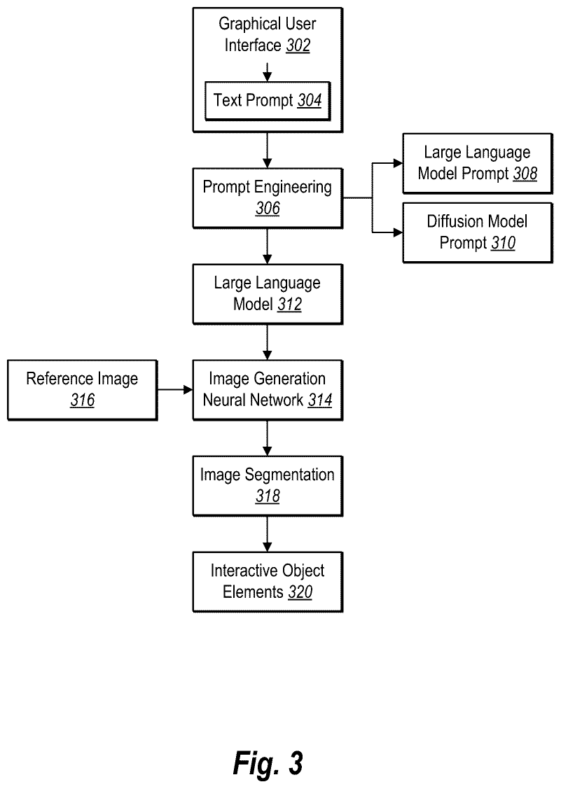

As further shown in FIG. 2, the thematic element system, in some embodiments, utilizes a large language model (“LLM”) 204 to generate a list of objects related to the theme 202. In various embodiments, the thematic element system 102 utilizes LLM prompt engineering to guide the LLM 204 in generating a list of objects related to (or most related to) the theme 202, as discussed further below. For example, the thematic element system 102 instructs the LLM 204 (e.g., utilizing natural language processing) to output a list of objects related to the theme 202. FIG. 3 and the corresponding description provide additional detail related to generating a list of objects related to a theme.

As further illustrated in FIG. 2, the thematic element system 102 utilizes an image generation neural network 206 (e.g., diffusion model) to generate a set of object elements based on the output of the LLM 204. In some cases, the thematic element system 102 employs the image generation neural network 206 to generate an intermediate digital image that includes a digital representation of each object specified in the output of LLM 204. For example, the thematic element system 102 generates one or more object elements representative of each object of the list of objects generated by large language model 204. In some cases, an image generation neural network refers to a generative neural network designed to create images based on learned patterns. Additionally, in one or more embodiments, an object element is a collection of pixels that visually represents an object, where the collection of pixels is discrete and individually separable from background pixels. FIGS. 3-6 and the corresponding description provide additional detail related to generating object elements utilizing an image generation neural network.

In some embodiments, the thematic element system 102 generates one or more interactive object elements 208 based on the one or more object elements generated by image generation neural network 206. In one or more embodiments, the interactive object elements are digital representations of objects related to the theme 202. For example, the thematic element system 102 generates an interactive object element 208 representing a cake in response to the theme 202 of “birthday party.” Specifically, in various embodiments, an interactive object element is a distinct visual element (e.g., embedded graphic element) that is manipulable (and selectable) within a digital image or digital application. In some embodiments, an interactive object element maintains resolution and editability when manipulated (e.g., translation, rotation, sizing), such as in vector image applications.

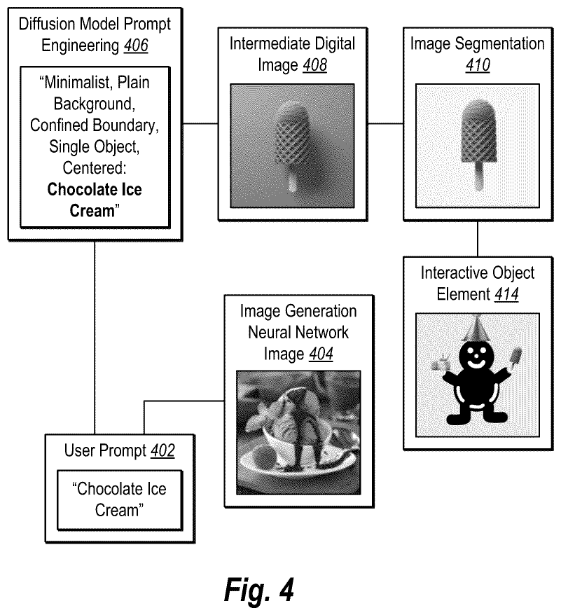

In various cases, the thematic element system 102 provides one or more interactive object elements 208 for display in a graphical user interface. In some cases, the thematic element system 102 generates interactive object elements 208 as individual digital elements in a digital image, subject to further use and/or manipulation by an editor of the digital image. In various cases, the thematic element system 102 enables various editing functions of the interactive object elements 208 (e.g., translation, rotation, resizing, etc.) in a graphical user interface of a digital image. FIGS. 4-5 and 8 and the corresponding description provide additional detail related to generating interactive object elements.

As just mentioned, in some embodiments, thematic element system 102 generates a set of one or more interactive object elements according to a theme. In certain embodiments, the thematic element system 102 generates interactive object elements corresponding to a user-defined theme, as determined from a text prompt. FIG. 3 illustrates a diagram of the thematic element system generating one or more interactive object elements based on a text prompt in accordance with one or more embodiments.

In some embodiments, the thematic element system 102 provides a field for entering a text prompt 304 to a user via a graphical user interface 302. In some cases, the thematic element system 102 provides the field within the graphical user interface 302, where interactive object elements 320 are provided. In one or more embodiments, the thematic element system 102 processes the text prompt 304 entered into the field to determine the theme, which serves as the basis for interactive object element generation. A text prompt, which accepts a single word, a phrase, or a short description, makes the thematic element generation accessible and straightforward for all types of users.

To generate a set of interactive object elements 320 (thematic digital elements), in some embodiments, the thematic element system 102 utilizes a large language model (e.g., LLM 312) to generate a list of objects relevant to a theme, which the thematic element system 102 uses in performing prompt engineering 306 (e.g., large language model prompt 308 and/or diffusion model prompt 310). Specifically, in various embodiments, the thematic element system 102 generates a refined diffusion model prompt 310. In some cases, the thematic element system 102 employs a text input source or text prompt 304 (e.g., single word, phrase, short description) to determine a theme which the thematic element system 102 uses to guide an LLM 312 in generating a list of thematic objects. Accordingly, in some embodiments, the thematic element system 102 provides an LLM prompt 308 to an LLM 312 that instructs the LLM 312 to generate a list of distinct objects that are representative (or most representative) of a theme indicated in the text prompt 304.

In one or more embodiments, the LLM 312 includes a machine learning model trained to perform computer tasks to generate textual content. A large language model includes a computer algorithm or a collection of computer algorithms trainable and/or tunable based on inputs to approximate unknown functions. A large language model includes a neural network (e.g., a deep neural network) that analyzes a language input to generate a predicted output. For example, a large language model includes a neural network that generates code based on a natural language query. In some cases, the large language model utilizes a transformer architecture, which includes mechanisms such as self-attention, to capture contextual relationships in the data.

For example, a large language model includes a neural network with branches, weights, or parameters that change based on training data to improve for a particular task. Thus, a large language model utilizes one or more learning techniques (e.g., supervised or unsupervised learning) to improve in accuracy and/or effectiveness. Similarly, as used herein, a neural network refers to a machine learning model of interconnected nodes (or neurons) organized into layers. A neural network includes parameters or weights between neurons that are adjusted during training to minimize the error (or measure of loss) in generating predictions.

Along these lines, the machine learning models used herein are trainable and/or fine-tunable based on a diverse text corpora to perform natural language processing tasks, such as generating code. For example, the machine learning models consist of layers of interconnected artificial neurons organized in encoder and decoder blocks, which learn complex language patterns to generate textual content. In some cases, the machine learning models include models or architectures that utilize self-attention mechanisms in natural language understanding and generation. In particular, in certain embodiments, a large language model refers to an artificial neural network trained by the preference-guided code generation system to generate code based on a set of natural language queries.

In some cases, the thematic element system 102 provides a diffusion model prompt 310 to an image generation neural network 314, which generates an intermediate digital image including one or more objects specified by the diffusion model prompt 310 (or other prompt suitable for a given image generation neural network), where the objects are related to a specific theme (as indicated by text prompt 304). For example, the thematic element system 102 generates a diffusion model prompt 310 that includes keywords and/or phrases to guide the image generation neural network 314 in creating a digital image with objects optimized for simple extraction and/or further manipulation.

In one or more embodiments, the thematic element system 102 generates a digital image that contains theme-specific objects by utilizing an image generation neural network 314 (e.g., diffusion service, diffusion model) guided by a reference image 316, as discussed in further detail below. For instance, the thematic element system 102 provides a reference image 316 to the image generation neural network 314, where the reference image 316 serves as a visual guide for the image generation neural network 314. In some cases, the reference image 316 influences the spatial arrangement and/or aesthetic consistency of generated objects within a digital image. As noted, in some cases, the image generation neural network 314 generates one or more digital images (e.g., intermediate digital images) that align with the theme and maintain a style and/or composition consistent with the provided reference image 316. FIGS. 12-19 provide additional detail related to diffusion models.

As further illustrated in FIG. 3, the thematic element system 102 isolates objects within a digital image by utilizing a segmentation neural network (e.g., via image segmentation 318). To illustrate, in one or more embodiments, the thematic element system 102 utilizes a segmentation neural network that applies advanced computer vision techniques to isolate (or crop) each object from the digital image generated by the image generation neural network 314, as discussed further below. In some cases, the segmentation neural network performs image segmentation 318 by returning a mask for each object along with its inverted mask to the thematic element system 102. For example, for images containing multiple objects, the thematic element system 102 uses a segmentation neural network to create a set of masks, where each mask corresponds to a specific object in the image. In some cases, the thematic element system 102 utilizes the masks to render an element for each object underlying the masks, allowing for the elements to be individually manipulated within a digital image.

As mentioned above, in certain described embodiments, the thematic element system 102 uses an LLM in combination with a diffusion service to produce one or more interactive object elements. For example, the thematic element system 102 generates a single interactive object element for use and/or manipulation within a digital image. FIG. 4 illustrates a diagram of the thematic element system generating a single interactive object element related to a theme in accordance with one or more embodiments.

As illustrated in FIG. 4, the thematic element system 102, in some cases, generates a single interactive object element 414. Traditional diffusion services alone may generate an image generation neural network image 404 (e.g., a single object digital image) including a digital object based on a user prompt 402. However, in these cases, the single object is highly integrated into its surroundings, not allowing for simple extraction/manipulation. For example, as illustrated in FIG. 4, the input “chocolate ice cream” determined from user prompt 402 to a conventional diffusion service results in generation of the image generation neural network image 404 that depicts chocolate ice cream. In the single object image (image generation neural network image 404), by way of illustration, the chocolate ice cream image has a mixed background, is not easily removed from the background, and contains many elements in addition to the ice cream (e.g., leaves, fruit, plate, bowl). Extracting solely the ice cream from this image is difficult, resulting in a complex digital object representing the theme or object identified in user prompt 402.

In contrast, the thematic element system 102 detects a theme or object from the user prompt 402. In some embodiments, the thematic element system 102 performs diffusion model prompt engineering 406. In one or more cases, the thematic element system 102 generates a diffusion model prompt including instructions to the image generation neural network (diffusion model) to construct an intermediate digital image 408. In various embodiments, the thematic element system 102 performs diffusion model prompt engineering 406 that includes instructions to aid in the removal and/or manipulation of digital object elements to be included in the intermediate digital image 408 so as to facilitate the removal of said digital object elements. In some embodiments, diffusion model prompt engineering refers to the generation of a set of instructions provided to an image generation neural network and includes detailed directives regarding the generation of a digital image.

In one or more embodiments, the thematic element system 102 performs diffusion model prompt engineering 406 such that the diffusion model prompt includes a prefix. For example, the thematic element system 102 generates a diffusion model prompt to include directions for a diffusion model such as “minimalist, plain background, confined boundary, single object, centered: chocolate ice cream.” In some cases, the thematic element system 102 includes “minimalist” as a keyword to encourage the diffusion model to generate images with simplicity and a clean design, avoiding unnecessary details. This makes the object (or objects) generated visually distinct and easier to use in various content layouts without distracting elements.

In certain embodiments, the thematic element system 102 includes “plain background” in the diffusion model prompt engineering 406. In one or more embodiments, this instruction causes the diffusion model to generate one or more objects on a simple, solid-colored or neutral background. A plain background makes it easier for a segmentation neural network to segment and isolate individual objects, facilitating their use as separate interactive object elements in design applications. In other cases, the thematic element system 102 includes the words “confined boundary” in diffusion model prompt engineering 406. This term guides the diffusion model to create an object within a specific area or border, ensuring that each object is complete, fully visible, and has defined edges. This makes the objects suitable for extraction without missing parts or overlapping boundaries.

In one or more cases, the thematic element system 102 specifies “single object” within the diffusion model prompt engineering 406. This keyword directs the model (image generation neural network) to focus on only generating only one object per image. This reduces the chances of clutter and overlap, providing a clear and distinct object that can be easily identified and extracted. In various embodiments, the thematic element system 102 directs the diffusion model, via diffusion model prompt engineering 406, to generate an object that is “centered.” Placing the object in the center of intermediate digital image 408 ensures that the object element is the primary focus and fully visible, which is often useful for image segmentation 410.

As further illustrated in FIG. 4, the thematic element system 102, utilizing a diffusion model, generates an intermediate digital image 408 (e.g., a single object image) based on the diffusion model prompt engineering 406. In some cases, the thematic element system 102 generates the intermediate digital image 408 to include an object element (digital object element) related to the theme as indicated by user prompt 402. Specifically, in some cases, the thematic element system 102 generates the intermediate digital image 408 to represent the theme as detected by the user prompt 402, in the manner as instructed by diffusion model prompt engineering 406.

As seen in FIG. 4, in one or more embodiments, the thematic element system 102 segments the intermediate digital image 408 to isolate a digital object element from the background of the intermediate digital image. In some cases, the thematic element system 102 utilizes a segmentation neural network, as further discussed below, to generate an interactive object element 414 based on a digital object element as found within intermediate digital image 408. In one or more embodiments, the segmentation neural network includes an encoder-decoder architecture, such as a U-Net architecture, a fully convolutional architecture, or a region-based convolutional architecture.

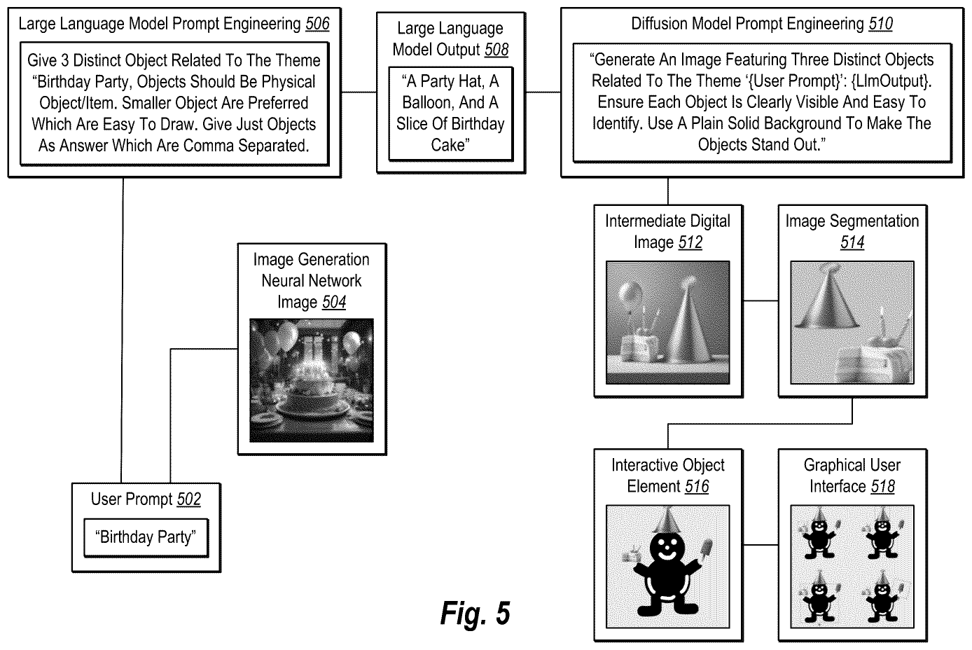

As noted above, in certain described embodiments, the thematic element system 102 utilizes diffusion model prompt engineering to generate one or more interactive object elements. In particular, the thematic element system 102 generates multiple thematic elements (interactive object elements) according to a theme as indicated by a user prompt. FIG. 5 illustrates a diagram of the thematic element system generating multiple interactive object elements in accordance with one or more embodiments.

As illustrated in FIG. 5, the thematic element system 102, based on a theme detected via a user prompt 502, generates one or more interactive object elements 516. As discussed previously, some traditional diffusion services generate an image generation neural network image 504 (e.g., a multi-object digital image) based on a user prompt 502. However, in these or other cases, the digital image contains object elements that are highly integrated with the background of the digital image, rendering segmentation of the digital elements complex.

Specifically, the thematic element system 102 generates the interactive object elements 516 for display and/or further manipulation within a graphical user interface 518. As shown, the thematic element system 102 performs LLM prompt engineering 506 to provide a set of instructions (via an LLM prompt) to a large language model.

To generate a list of objects related to the user prompt 502, the thematic element system 102, in some cases, instructs a large language model to generate a list of objects (e.g., LLM output 508) related to the theme as indicated by the user prompt 502. As shown in FIG. 5, and by way of illustration, the thematic element system 102 performs LLM prompt engineering 506 to provide an LLM prompt with the instructions: “Give 3 distinct objects related to the theme ‘birthday party,’ objects should be physical objects/items. Smaller objects are preferred which are easy to draw. Give just objects as answer which are comma separated.”

In particular, the thematic element system 102 performs LLM prompt engineering 506 by generating a prefix and a suffix. The prefix serves as the foundation of the prompt and directly sets the context for the LLM. Specifically, the thematic element system 102, in some cases, generates a prefix stating “Give [a number] of distinct objects related to [userPrompt].” By stating “Give [a number] of distinct objects,” the prompt explicitly instructs the large language model to generate a specific number of separate, unique objects that are associated with the theme as indicated by the user prompt 502. In some cases, by using “distinct,” the thematic element system 102 ensures that the objects suggested by the LLM are not redundant or overlapping in nature but rather represent diverse aspects of the theme.

In one or more embodiments, the thematic element system 102 utilizes prefix wording as discussed above to effectively narrow the LLM's focus to a manageable number of outputs (for example, three), preventing the LLM from generating a lengthy or overly detailed list. In addition, in various cases, the thematic element system 102 specifically requests “distinct objects” to drive the LLM to provide a variety of items, enhancing the creative potential for interactive object elements 516 within a graphical user interface 518. For example, for the theme related to user prompt “birthday,” the prefix prompts the LLM to suggest diverse objects such as “balloons, cake, candles” instead of similar or redundant items like “cake, cupcake, pie.” The variety is useful for generating unique and versatile visual elements (digital object elements within an intermediate digital image 512) that are relevant to the input theme.

In various embodiments, the thematic element system 102 utilizes a suffix to provide additional instructions to the LLM to refine LLM output 508 further, specifying the type and/or nature of the objects the LLM should generate. For example, the LLM prompt engineering 506 includes a suffix that states “objects should be physical items, smaller items preferred, easy to draw. Provide only objects, comma-separated.” In some cases, the thematic element system 102 includes the wording “physical items” as a directive to ensure that the LLM focuses on tangible, real-world objects rather than abstract concepts or ideas. In some cases, by using “physical items” in the suffix, the thematic element system 102 represents explicitly generates items that are easier to represent visually, which is important for a content creation tool.

In one or more embodiments, the thematic element system 102 also includes “smaller objects preferred” in LLM prompt engineering 506. By preferring smaller objects, the LLM prompt guides the LLM to suggest items that are visually manageable and easy to manipulate within design applications (e.g., graphical user interface 518). Smaller objects, like “cup” or “leaf,” are typically simpler to draw, isolate, and reuse in various creative contexts. In some cases, the thematic element system 102 also (or alternatively) generates a suffix that includes “easy to draw.” This criterion further ensures that the selected objects are straightforward to represent visually, reducing the complexity for the image generation neural network (e.g., diffusion model). For example, objects like “apple” or “star” are interpreted as simpler and less intricate (and thus easier to draw) compared to “cityscape” or “mountain range.” In some embodiments, the thematic element system 102 performs LLM prompt engineering 506 that specifies “provide only objects, comma separated.” This directive ensures clarity and format consistency in the output, making the objects in LLM output 508 easier to parse and use in diffusion model prompt engineering 510. Such wording, in some cases, limits LLM output 508 to a concise list, enhancing the ease of processing and automation.

The thematic element system 102, in one or more embodiments, generates a suffix in LLM prompt engineering 506 to refine LLM output 508 to be more suitable for generating object elements that can be easily visualized and extracted. The suffix filters out complex or irrelevant suggestions, ensuring the objects in LLM output 508 are small, manageable, and fit well within a drawing (digital image) or content creation application. For instance, instead of suggesting “a party scene,” the LLM is more likely to suggest simple items like “balloon, hat, gift,” which are easily isolated and/or utilized individually. Additionally, by using the “comma-separated” format, LLM output 508 is straightforward to interpret programmatically, facilitating the smooth transition to diffusion model prompt engineering 510 and reducing computational expenditures.

In some cases, the thematic element system 102 performs diffusion model prompt engineering 510. In particular, the thematic element system 102 generates a diffusion model prompt to guide a diffusion model (image generation neural network) in creating an intermediate digital image 512. In one or more embodiments, the diffusion model, in response to LLM output 508, prompt instructs a diffusion model to generate a digital image (e.g., intermediate digital image 512) that includes the objects listed in LLM output 508. The thematic element system 102, in combination with a diffusion model that uses generative artificial intelligence, creates a single digital image that contains digital object elements representative of the objects included in the LLM output (e.g., a list of distinct objects related to a theme).

In various embodiments, the thematic element system 102 performs diffusion model prompt engineering 510 by generating a prefix (as described previously in FIG. 4) and a suffix. The suffix, in some embodiments, includes wording such as “high separation between objects, cornered objects, clearly visible, less overlap, less gradient, plain solid background.” The suffix, in various cases, includes one or multiple of these instructions. As illustrated in FIG. 5, and by way of example, diffusion model prompt engineering 510 includes a prompt stating “Generate an image featuring three distinct objects related to the theme ‘{user prompt}’: {llmOutput}. Ensure each object is clearly disable and easy to identify. Use a plain solid background to make the objects stand out.”

In one or more embodiments, the thematic element system 102 performs diffusion model prompt engineering 510 to include instructions specifying “high separation between objects.” This phrase instructs the model to generate images where multiple objects (if present) are clearly separated from each other. This reduces visual clutter and simplifies isolating each object during image segmentation 514. In some cases, the thematic element system 102 specifies “cornered objects” in the diffusion model prompt. This directs the model to consider placing any secondary objects (if any) near the corners, minimizing overlap with the primary object. This helps ensure the main object remains the focal point and remains fully extractable.

In some cases, the thematic element system 102 specifies that the intermediate digital image 512 should contain object elements that are “clearly visible.” This wording ensures that the generated object elements are well-defined, with sufficient contrast against the background to make them easily distinguishable, which is useful for visual clarity and the effectiveness of object segmentation (via image segmentation 514). In one or more cases, the thematic element system 102 specifies “less overlap” in the diffusion model prompt. This specification minimizes the chance that object elements within intermediate digital image 512 will be placed on top of each other or too close together, ensuring that the thematic element system 102 is able to extract and/or use each object element individually without interference from adjacent object elements.

In one or more embodiments, the thematic element system 102 generates a diffusion model prompt with a suffix including “less gradient.” The thematic element system 102 thus reduces the use of gradients or color transitions that complicate object boundaries. A less gradient background also helps in maintaining sharp, distinct edges, which is useful for image segmentation 514 in some implementations. Alternatively, or additionally, the thematic element system 102 instructs the diffusion model to generate intermediate digital image 512 to have object elements that have a “plain solid background.” The thematic element system 102 thus generates an intermediate digital image with a non-distracting, uniform background that aids in object extraction by providing a clear contrast between the object element(s) and their surroundings.

In various cases, the thematic element system 102 generates the intermediate digital image 512 that contains thematic digital object elements in a single style or aesthetic. Due to the nature of the generative AI system, the thematic element system generates the intermediate digital image such that the object elements within the image have similar lighting or other aesthetic qualities. Furthermore, the thematic element system 102, in some cases, generates the intermediate digital image such that the thematic element system 102 is able to extract the object elements by image segmentation 514, which is discussed in greater detail below.

As illustrated in FIG. 5, the thematic element system 102 generates one or more interactive object elements 516. The thematic element system 102 generates interactive object elements 516 based on the object elements in the intermediate digital image 512 as identified by image segmentation 514 utilizing a segmentation neural network. In some cases, the thematic element system 102 provides the interactive object elements for display and/or manipulation within a graphical user interface 518. In one or more embodiments, the thematic element system 102 employs the multi-object pipelines of FIG. 5 and the single-object pipeline of FIG. 4 simultaneously. In some cases, the thematic element system 102 employs this dual technique to generate interactive digital elements according to two separate themes.

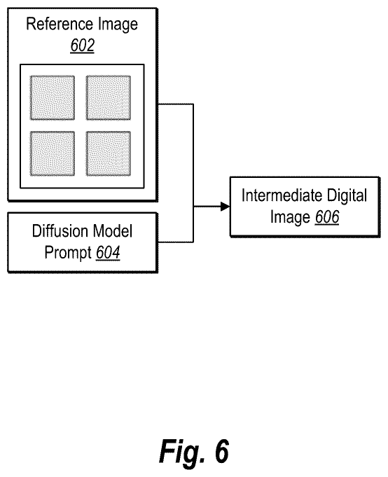

As mentioned above, in certain described embodiments, the thematic element system 102 generates an intermediate digital image by utilizing a diffusion model prompt. Specifically, in some cases, the thematic element system 102 generates the intermediate digital image by pairing instructions in a diffusion model prompt with a reference image. FIG. 6 illustrates a diagram of the thematic element system utilizing a reference image in generating an intermediate digital image in accordance with one or more embodiments.

In some cases, the thematic element system 102 generates an intermediate digital image by using a reference image 602 in combination with a text prompt to a diffusion model. The thematic element system 102 provides a reference image 602 and a diffusion model prompt 604 to an image generation neural network to generate an intermediate digital image. In one or more embodiments, the reference image provides visual guidance to the image generation neural network to guide placement of digital object elements within the intermediate digital image 606.

In some cases, the reference image 602 contains specific characteristics to guide the visual composition of the intermediate digital image 606. In some embodiments, the reference image 602 is of a simple composition. For example, a composition refers to or includes the arrangement of elements (e.g., lines, shapes, spaces) within an image. Specifically, the reference image 602 contains a predefined number of geometric sections with clear, distinct boundaries. For instance, the reference image 602, as illustrated in FIG. 6, contains a grid of four individual square sections. The simplicity of this design (or composition) causes generated object elements to have a specific, confined space in which they appear. This helps maintain separation between different objects and reduces overlap, making the extraction and isolation of each object easier. Although the reference image 602 of FIG. 6 includes four separate sections, in other embodiments, the thematic element system 102 provides reference images with different numbers of sections (e.g., 1 or 2) configured with a specific spatial arrangement.

In other embodiments, the thematic element system 102 utilizes a reference image 602 with a plain and/or untextured background, which ensures that there are no distracting elements in the background that might interfere with the clarity of the generated objects. In one or more embodiments, the thematic element system 102 utilizes a reference image with a plain background to create a neutral canvas that allows the diffusion model to focus solely on the objects themselves. In various cases, the thematic element system 102 generates intermediate digital image 606 based on a reference image 602 with clear boundaries around visually distinct regions, with each of the visually distinct regions in the reference image separated by distinct, bold lines. These boundaries serve to encourage the diffusion model to generate object elements that are confined within their respective sections, preventing them from blending or merging with adjacent objects.

In one or more cases, the thematic element system 102 provides a reference image 602 with centered and isolated object placement to a diffusion model. The structure of the reference image 602 suggests that each object should be centered within its respective quadrant, which causes the diffusion model to generate whole objects, without parts being cut off or hidden. Additionally, isolation allows for a higher-quality extraction of objects with well-defined edges. In other cases, the thematic element system 102 utilizes a reference image 602 to encourage uniform object distribution for uniformity in the placement of objects, which is helpful in maintaining a balanced composition and visual consistency, especially when the object elements are used as interactive object elements in a digital image.

In one or more embodiments, clear boundaries and a plain background in the reference image 602 improve the straightforwardness of image segmentation. The thematic element system 102, in utilizing a segmentation neural network, thus easily identifies where one object ends and another begins for precise isolation of each object. Additionally, the thematic element system 102 further reduces computational complexity and potential errors in segmenting objects that may otherwise have blended together. Additionally, a reference image 602 with distinct sections and separation lines inherently discourages overlap between objects. By guiding the diffusion model to place each object within its own space, the thematic element system 102, in combination with the reference image 602, reduces the likelihood of objects merging or obscuring one another and generates object elements that are distinct and individually usable.

In some cases, the predefined dimensions of the shapes (e.g., squares) in a grid of the reference image 602 standardize the size and positioning of the object elements generated in the intermediate digital image 606. Accordingly, the thematic element system 102 provides consistency for applications where uniformity in element dimensions is important, such as digital content creation or drawing applications including tools for resizing or repositioning interactive object elements. As mentioned, in one or more embodiments, the thematic element system 102 utilizes reference image 602 as a template or guide for the diffusion model, providing a compositional structure that the diffusion model uses to generate intermediate digital image 606 that includes one or more digital object elements. For example, the thematic element system 102 provides reference image 602 and diffusion model prompt 604 to an image generation neural network to produce an intermediate digital image 606 that includes a symmetrical arrangement and equal spacing, contributing to an aesthetically balanced output while generating clear, distinct object elements with minimal overlap and strong visual boundaries. In one or more embodiments, the intermediate digital image 606 includes objects with visually distinct object boundaries in which the objects have a line, color, or other visual boundary and are separate from other objects by some amount of space (e.g., based on the visually distinct regions of the reference image 602).

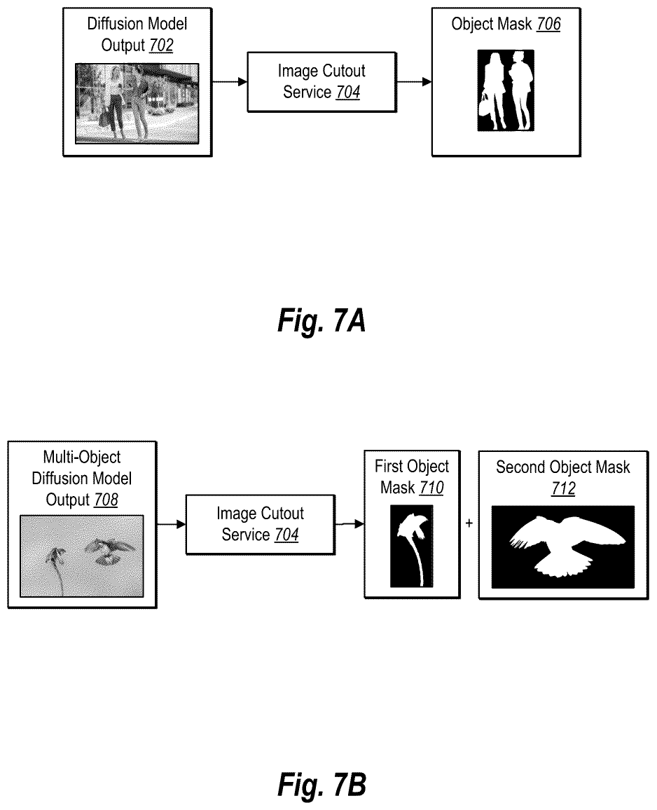

As mentioned previously, in one or more embodiments, the thematic element system 102 utilizes a segmentation neural network to generate interactive object elements. In particular, the thematic element system 102 uses a masking function to identify and isolate object elements from an intermediate digital image. FIGS. 7A-7B illustrate diagrams of the segmentation neural network of the thematic element system isolating digital elements within an intermediate digital image in accordance with one or more embodiments.

As illustrated in FIG. 7A, in some embodiments, the thematic element system 102 generates an object mask for a single object and/or single element. For example, the thematic element system 102 performs a mask and crop function (image cutout service 704) on a diffusion model output 702. Specifically, the thematic element system 102 utilizes a segmentation neural network to generate a mask of an identified object within the diffusion model output 702 (e.g., an intermediate digital image) and, based on the mask, crop the digital image. Furthermore, the thematic element system 102 performs the cropping function by isolating the digital pixels beneath the mask from the surrounding pixels (e.g., the background of the intermediate digital image).

In particular, the thematic element system 102 utilizes a segmentation neural network to employ an image cutout service 704 designed for entity segmentation, where the image cutout service 704 detects the most salient object in an image. Furthermore, in one or more embodiments, the thematic element system 102 utilizes the image cutout service 704 to provide an object mask 706 for the most salient object as Base64-encoded image data. In response to the mask generation, the thematic element system 102 returns a mask for that object (e.g., object mask 706) along with the inverted mask for that object.

As illustrated in FIG. 7B, the thematic element system 102 generates utilizes an image cutout service (e.g., via a segmentation neural network) to generate multiple interactive object elements. In one or more embodiments, the thematic element system 102, in combination with the image cutout service 704, generates multiple object masks from a multi-object diffusion model output 708. The thematic element system 102 employs an image cutout service 704 that generates a distinct mask for each object detected in the multi-object diffusion model output 708. Unlike traditional segmentation methods that often assign the same mask to all objects of the same class, the thematic element system 102 utilizes the image cutout service 704 to generate individual masks for each of the detected objects. In particular, the thematic element system 102 generates a distinct mask for each object even if there is no predefined label or class associated with the object.

In one or more cases, the thematic element system 102 generates an object mask according to each object detected within the multi-object diffusion model output 708. For example, as illustrated in FIG. 7B, for a multi-object diffusion model output 708 that contains a picture of two birds, the image cutout service 704 returns a first object mask 710 associated with the first bird and a second object mask 712 associated with the second bird. The resulting masks are detailed and specific to each object, ensuring precise isolation of each element from the others and the background. To further illustrate, in a birthday-themed image, the thematic element system 102 assigns each balloon, cake, and candle its own masks for quickly identifying and isolating each object separately from the other elements and from the background.

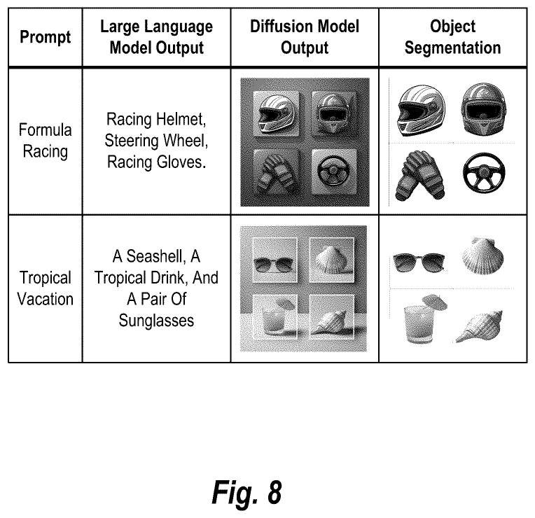

As just discussed, the thematic element system 102 utilizes a segmentation neural network to isolate object elements from an intermediate digital image. In particular, the image cutout service returns a set of object elements relating to a user-defined theme. FIG. 8 illustrates the thematic element system generating sets of object elements in accordance with one or more embodiments.

As illustrated in FIG. 8, the thematic element system 102 generates a set of object elements according to a theme by utilizing an LLM and a diffusion model. In particular, the thematic element system 102 detects a prompt (e.g., a text prompt including a theme) as defined by a user. In some embodiments, the thematic element system 102 utilizes an LLM to output a list of objects related to a theme defined via a user input. For example, for a user input of “formula racing,” the LLM output lists “racing helmet, steering wheel, racing gloves.”

As further illustrated in FIG. 8, the thematic element system 102 utilizes a diffusion model to generate an intermediate digital image (diffusion model output) that provides visual representations of the objects listed in the LLM output. In various embodiments, the thematic element system 102 segments the intermediate digital image generated by the diffusion model to isolate the individual object elements. For example, the thematic element system 102 isolates two racing helmets, a steering wheel, and racing gloves from a blue background and further from the individual squares containing each of the object elements.

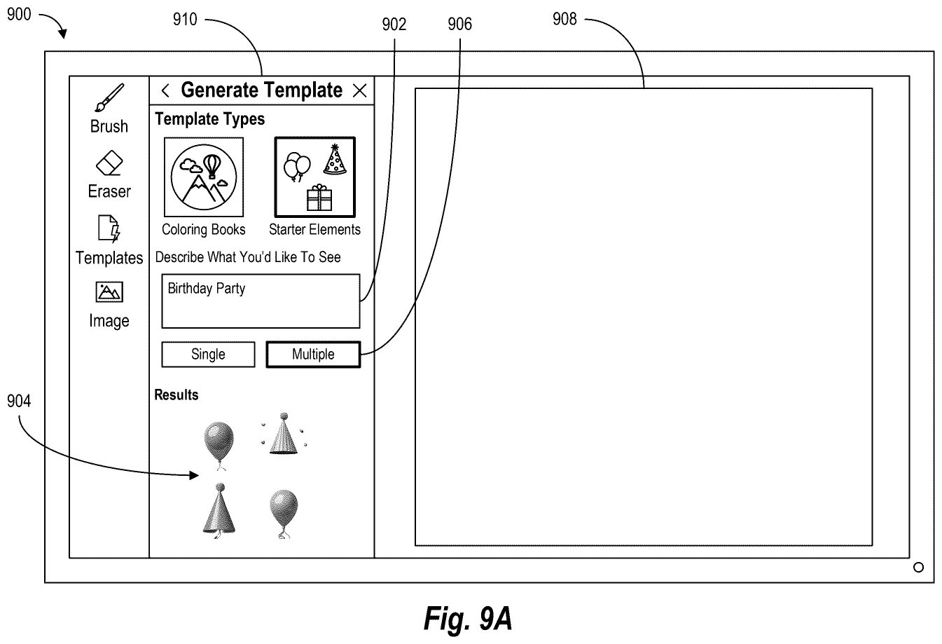

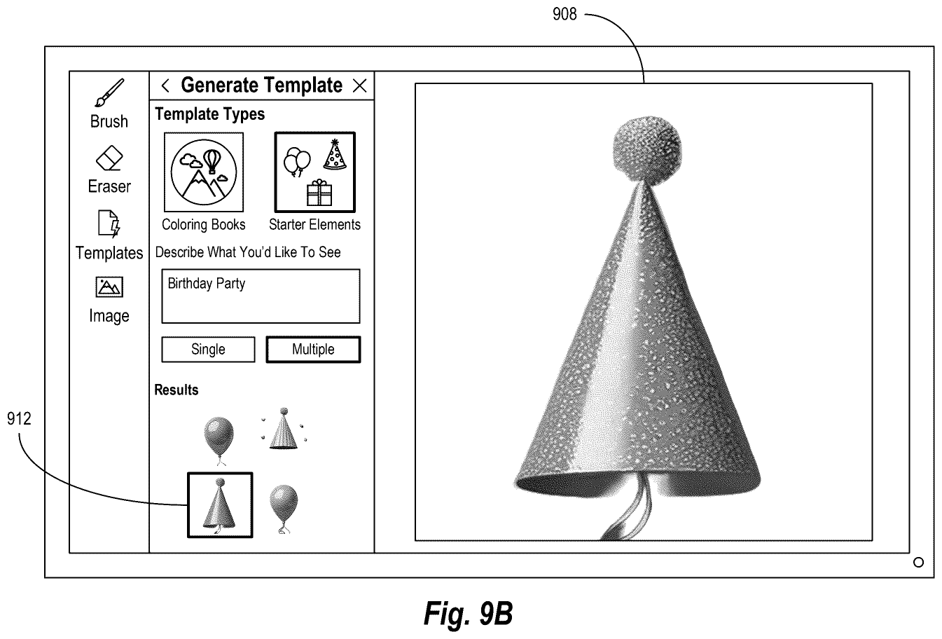

As noted above, in certain embodiments, the thematic element system 102 generates one or more interactive object elements for display within a graphical user interface. In addition, the thematic element system 102 generates the interactive object elements for easy manipulation within the graphical user interface. FIG. 9A-9B illustrate an example of the thematic element system providing interactive object elements in a digital image in accordance with one or more embodiments.

As illustrated in FIG. 9A, the thematic element system 102 provides a user interface 900 for generating or modifying a digital image. In one or more embodiments, the user interface 900 includes a canvas 908 for direct manipulation of the digital image and/or a template interface 910 for generating thematic elements (interactive object elements). In particular, the thematic element system 102 provides an input box 902 or field for a user to input text indicating a particular theme. Based on that theme, the thematic element system 102, in some cases, generates a set of interactive object elements 904 in a pane of the graphical user interface (e.g., a template interface 910). The thematic element system 102, via the user interface 900, allows users to indicate a text prompt for quickly generating elements based on a single item or an entire theme.

In various embodiments, the thematic element system 102 provides an option to a user of the generation of single or multiple interactive object elements. To facilitate the selection of single versus multiple interactive object elements, the thematic element system 102, in some embodiments, provides a single object button and/or a multi-object button 906 within the user interface 900. For example, by entering text in the input box 902 and selecting the multi-object button 906, the thematic element system 102 generates multiple interactive object elements 904 for use within the canvas 908.

As shown in FIG. 9B, the thematic element system 102 allows a user to select a generated interactive user element 912 to further manipulate (translation, rotation, scaling, etc.) in a canvas 908 for creating a digital image. In some cases, when an artist (user) taps on an interactive object element within the graphical user interface, the thematic element system 102 provides a transform bounding box for the interactive object element within the graphical user interface (e.g., canvas 908) for resizing, rotating, or moving the element within a digital image. Furthermore, in various embodiments, in response to inserting one or more interactive object elements into a digital image, the thematic element system 102 provides tools to allow artists to continue drawing with different brushes or other tools to complete their artwork including the one or more interactive object elements.

In some embodiments, the thematic element system 102 generates a personalized experience by recommending interactive object elements based on previous interactions with the feature. For example, in cases where a user has repeatedly selected objects of a particular color, the thematic element system 102 generates interactive object elements of that previously selected color. To illustrate, the thematic element system 102 uses previous interactions selecting interactive object elements with specific characteristics to generate prompts to provide to a LLM and/or an image generation neural network.

In various cases, the thematic element system 102 auto-populates the canvas 908 (or digital image) with a number of interactive object elements. The thematic element system, in some embodiments, auto-populates the canvas 908 with the first interactive object element. In other cases, the thematic element system 102 auto-populates the digital image with a predetermined number of interactive object elements. In these or other cases, the thematic element system 102 auto-populates the digital image with a number or type of interactive object elements based on previous interactions with the feature. For example, in cases where a user repeatedly selects the first two interactive object elements, the thematic element system 102, upon generating a set of interactive object elements, auto-populates a digital image with the first two interactive object elements of the set of interactive object elements.

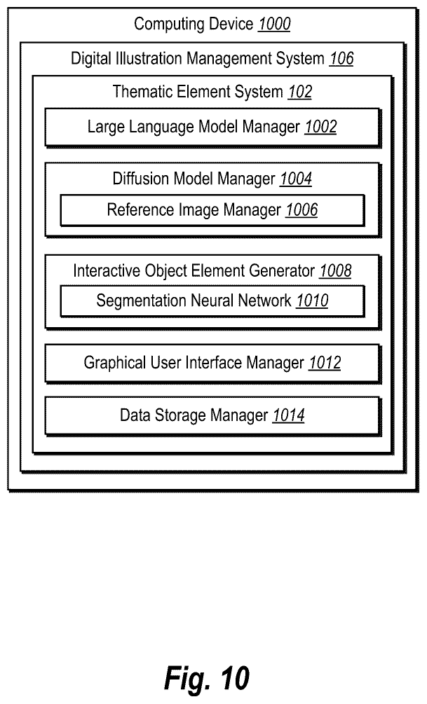

Looking now to FIG. 10, additional detail will be provided regarding components and capabilities of the thematic element system 102. Specifically, FIG. 10 illustrates an example schematic diagram of the thematic element system 102 on an example computing device 1000 (e.g., one or more of the client device 110 and/or the server device(s) 104). In some embodiments, the computing device 1000 refers to a distributed computing system where different managers are located on different devices, as described above. As shown in FIG. 10, the thematic element system 102 includes a large language model manager 1002, a diffusion model manager 1004, an interactive object element generator 1008, and a graphical user interface manager 1012.

As just mentioned, the thematic element system 102 includes a large language model manager. In particular, the large language model manager 1002 manages, maintains, guides, or identifies a large language model to generate a list of objects related to a theme. For example, the large language model manager 1002 detects user input within a digital image (e.g., text input, voice input, image input) and utilizes the input as a guide to generate a prompt for a large language model. Specifically, the large language model manager 1002 instructs the large language model (“LLM”) to output a predefined number of distinct objects related to a theme as defined by the user input. Additionally, in some cases, the large language model manager 1002 generates a prompt instructing the LLM to generate a list of objects related to the user defined theme that are tangible objects, smaller objects preferred, and/or that are easy to draw.

As shown, the thematic element system 102 also includes a diffusion model manager 1004. In particular, the diffusion model manager 1004 manages, maintains, generates, determines, or identifies a diffusion model prompt to provide to a diffusion model (e.g., image generating neural network). For example, the diffusion model manager 1004, in cases involving generating a single interactive object element, utilizes user input denoting an object or theme to generate an intermediate digital image including an object element representing the theme/object as defined by the user input. In other cases, such as those involving the generation of a set of interactive object elements, the diffusion model manager 1004 generates a diffusion model prompt to guide a diffusion model to generate an intermediate digital image that includes a plurality of object elements representing the output of an LLM, as guided by large language model manager 1002.

As illustrated in FIG. 10, the diffusion model manager 1004 includes reference image manager 1006. In particular, the reference image manager 1006 utilizes a reference image to guide a diffusion model in the generation of an intermediate digital image that includes distinct object elements representative of the objects listed by the large language model. Additionally, in some embodiments, the reference image manager 1006 utilizes a reference image to promote spatial and/or aesthetic consistency in the generation of the intermediate digital image.

As further illustrated in FIG. 10, the thematic element system 102 includes an interactive object element generator 1008. The interactive object element generator operates in conjunction with, or includes the large language model manager 1002, the diffusion model manager 1004, and/or the graphical user interface manager 1012. As shown, the interactive object element generator 1008 includes a segmentation neural network 1010 accessible and usable by other components of the thematic element system 102. In some cases, the thematic element system 102 utilizes the segmentation neural network 1010 to identify and isolate element objects within the intermediate digital image. For example, the segmentation neural network 1010 generates and returns a mask for each object within the intermediate digital image.

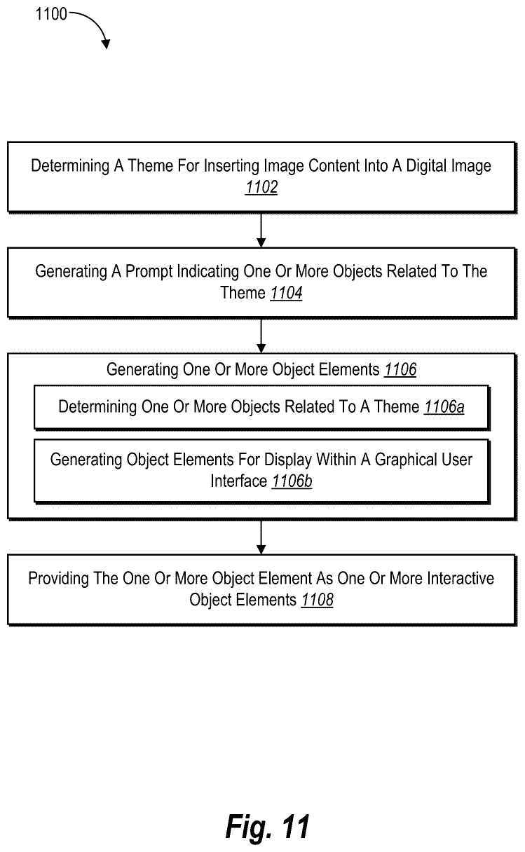

As shown in FIG. 11, the thematic element system 102 includes a graphical user interface manager 1012. In particular, the graphical user interface manager 1012 manages, maintains, generates, determines, or identifies user interactions with a graphical user interface. For example, the graphical user interface manager 1012 allows a user to manipulate interactive object elements for use within a digital image.

The thematic element system 102 also includes a data storage manager 1014 (that comprises a non-transitory computer memory) that stores and maintains data associated with generating interactive object elements based on a theme. For example, the data storage manager 1014 stores user inputs indicating themes and one or more prompts to one or more neural networks. Additionally, the data storage manager 1014 stores data associated with generating and utilizing neural networks, including lists of objects generated by a large language model, image data generated by an image generation neural network, and/or segmentations generated by a segmentation neural network.

In one or more embodiments, each of the components of the thematic element system 102 are in communication with one another using any suitable communication technologies. Additionally, the components of the thematic element system 102 is in communication with one or more other devices including one or more client devices described above. It will be recognized that although the components of the thematic element system 102 are shown to be separate in FIG. 10, any of the subcomponents may be combined into fewer components, such as into a single component, or divided into more components as may serve a particular implementation. Furthermore, although the components of FIG. 10 are described in connection with the thematic element system 102, at least some of the components for performing operations in conjunction with the thematic element system 102 described herein may be implemented on other devices within the environment.

The components of the thematic element system 102, in one or more implementations, includes software, hardware, or both. For example, the components of the thematic element system 102 include one or more instructions stored on a computer-readable storage medium and executable by processors of one or more computing devices (e.g., the computing device 1000). When executed by the one or more processors, the computer-executable instructions of the thematic element system 102 cause the computing device 1000 to perform the methods described herein. Alternatively, the components of the thematic element system 102 comprises hardware, such as a special purpose processing device to perform a certain function or group of functions. Additionally, or alternatively, the components of the thematic element system 102 includes a combination of computer-executable instructions and hardware.

Furthermore, the components of the thematic element system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the thematic element system 102 may be implemented as part of a stand-alone application on a personal computing device or a mobile device. Alternatively, or additionally, the components of the thematic element system 102 may be implemented in any application that allows creation and delivery of marketing content to users, including, but not limited to, applications in ADOBE® CREATIVE CLOUD®, such as ADOBE® PHOTOSHOP®, ADOBE® ILLUSTRATOR®, ADOBE® EXPRESS®, and ADOBE® FIREFLY®, which are either registered trademarks or trademarks of Adobe Inc. in the United States and/or other countries.

FIGS. 1-10, the corresponding text, and the examples provide a number of different systems, methods, and non-transitory computer readable media for generating one or more interactive object elements consistent with a determined theme by using a large language model in conjunction with an image generation neural network. In addition to the foregoing, embodiments are describable in terms of flowcharts comprising acts for accomplishing a particular result. For example, FIG. 11 illustrates a flowchart of example sequences or series of acts in accordance with one or more embodiments.

While FIG. 11 illustrates acts according to particular embodiments, alternative embodiments may omit, add to, reorder, and/or modify any of the acts shown in FIG. 11. The acts of FIG. 11 are sometimes performed as part of a method. Alternatively, a non-transitory computer readable medium comprises instructions, that when executed by one or more processors, cause a computing device to perform the acts of FIG. 11. In still further embodiments, a system performs the acts of FIG. 11. Additionally, the acts described herein may be repeated or performed in parallel with one another or in parallel with different instances of the same or other similar acts.

FIG. 11 illustrates a flowchart of a series of acts for generating a one or more thematic elements by utilizing a user input indicating a theme in combination with a diffusion model in accordance with one or more embodiments. In particular, the series of acts 1100 includes an act 1102 of determining a theme for inserting image content into a digital image. For example, the act 1102 involves determining, by at least one processor and from a text input via a graphical user interface, a theme for inserting image content into a digital image within the graphical user interface. In addition, the series of acts 1100 includes an act 1104 of generating a prompt indicating one or more objects related to the theme. For example, the act 1104 includes generating, by the at least one processor in response to the text input, a prompt indicating one or more objects related to the theme.

As further illustrated in FIG. 11, the series of acts 1100 includes an act 1106 of generating one or more object elements. For example, the act 1106 involves generating, by the at least one processor utilizing a diffusion model according to the prompt, one or more object elements corresponding to the one or more objects related to the theme for display within the graphical user interface. In particular, the act 1106 includes an act 1106a of determining one or more objects related to a theme. Additionally, the act 1106 includes an act 1106b of generating object elements for display within a graphical user interface.

Additionally, the series of acts 1100 includes an act 1108 of providing the one or more object elements as one or more interactive object elements. For example, the act 1108 involves providing, by the at least one processor and for display in the graphical user interface, the one or more object elements as one or more interactive object elements for inserting into the digital image.

In one or more embodiments the series of acts 1100 includes an act of generating the one or more object elements by providing a reference image to the diffusion model comprising a style, a layout, or a composition for the one or more object elements. In addition, the series of acts 1100 includes generating the one or more object elements in the style, the layout, or the composition of the reference image. In some cases, the series of acts 1100 includes an act of generating the one or more object elements by providing a reference image to the diffusion model that causes the diffusion model to generate the one or more object elements in a spatial arrangement based on the reference image.

In certain embodiments, the series of acts 1100 includes generating the one or more object elements further by generating the one or more object elements in a spatial arrangement that is based on a plurality of visually distinct regions of the reference image, causing the one or more object elements to be positioned according to the plurality of visually distinct regions.

In some embodiments, the series of acts 1100 includes an act of generating the prompt indicating one or more objects related to the theme to include one or more key words that cause the diffusion model to generate an intermediate digital image including the one or more object elements with visually distinct object boundaries. Additionally, the series of acts 1100 includes an act of generating, from the intermediate digital image including the one or more object elements, the one or more interactive object elements for display in the graphical user interface by segmenting the one or more object elements according to the visually distinct object boundaries.

In one or more embodiments, the series of acts 1100 includes generating the one or more interactive object elements by determining, from the intermediate digital image and utilizing a segmentation neural network, one or more object masks according to the one or more object elements with visually distinct object boundaries. In addition, the series of acts 1100 includes generating, utilizing the one or more object masks, the one or more interactive object elements by cropping the one or more object elements from the intermediate digital image.

In some embodiments, the series of acts 1100 includes determining, from a text input via a graphical user interface, a theme for inserting image content into a digital image within the graphical user interface. The series of acts 1100 also includes generating a first prompt comprising the theme to cause a large language model to generate a list of objects related to the theme. The series of acts 1100 further includes generating a second prompt comprising the list of objects related to the theme to cause a diffusion model to generate one or more object elements corresponding to the list of objects. Additionally, the series of acts 1100 includes providing, for display in the graphical user interface, the one or more object elements as one or more interactive object elements for inserting into the digital image.

In some cases, the series of acts 1100 includes an act of generating the first prompt by generating, in response to determining the theme from the text input via the graphical user interface, instructions for a large language model to generate text including a list of distinct objects representative of the theme.

In various cases, the series of acts 1100 includes an act of generating the second prompt comprising the list of objects related to the theme to cause the diffusion model to generate the one or more object elements corresponding to the list of objects by generating instructions for the diffusion model to generate an intermediate digital image comprising the one or more object elements based on the list of objects related to the theme. Additionally, in some cases, the series of acts 1100 includes an act of generating, from the intermediate digital image, the one or more interactive object elements for inserting into the digital image.

In some embodiments, the series of acts 1100 includes an act of generating the one or more interactive object elements further by segmenting each object element of the one or more object elements of the intermediate digital image utilizing a segmentation neural network. In addition, the series of acts 1100 includes an act of generating the one or more interactive object elements by generating one or more separate digital images including the one or more object elements in response to segmenting each object element utilizing the segmentation neural network. Furthermore, the series of acts involves generating one or more masks representing the one or more object elements of the intermediate digital image utilizing the segmentation neural network. Additionally, the series of acts 1100 includes an act of generating the one or more separate digital images from the one or more masks representing the one or more object elements.

In one or more embodiments, the series of acts 1100 includes an act of generating the first prompt by generating, in response to determining the theme from the text input, the first prompt with instructions to generate a plurality of distinct, physical objects in a comma-separated list.

In various embodiments, the series of acts 1100 includes an act of generating the second prompt by providing, to the diffusion model with the text prompt, a reference image including regions with visually distinct boundaries. In addition, the series of acts 1100 involves providing, to the diffusion model, a text prompt to generate an intermediate digital image based on the list of objects related to the theme according to the reference image.

In some cases, the series of acts 1100 includes an act of providing the one or more object elements as the one or more interactive object elements by generating, for display in the graphical user interface, a plurality of selectable digital images including the one or more object elements. Additionally, the series of acts 1100 includes an act of providing, for display in the graphical user interface, the plurality of selectable digital images including the one or more object elements as the one or more interactive object elements for inserting into the digital image.

In one or more cases, the series of acts 1100 includes determining, from a text input via a graphical user interface, a theme for inserting image content into a digital image within the graphical user interface. The series of acts 1100 also includes generating, in response to the text input, a prompt indicating one or more objects related to the theme. Additionally, the series of acts 1100 includes generating, by utilizing a diffusion model according to the prompt, one or more object elements corresponding to the one or more objects related to the theme for display within the graphical user interface. The series of acts 1100 also includes providing, for display in the graphical user interface, the one or more object elements as one or more interactive object elements for inserting into the digital image.

In certain embodiments, the series of acts 1100 includes an act of generating an additional prompt comprising instructions to cause a large language model to generate text including a list of objects related to the theme. Further, the series of acts 1100 includes acts of generating the prompt indicating the one or more objects related to the theme from the list of objects generated by the large language model.

In some embodiments, the series of acts 1100 includes auto-populating the one or more interactive object elements into the digital image within the graphical user interface.

In one or more cases, the series of acts 1100 includes an act of generating one or more interactive object elements by generating the prompt indicating one or more objects related to the theme comprising one or more key words that cause the diffusion model to generate an intermediate digital image including the one or more object elements with visually distinct object boundaries according to visually distinct regions in a reference image. Additionally, the series of acts 1100 includes an act of generating, from the intermediate digital image including the one or more object elements, the one or more interactive object elements for display in the graphical user interface.

In some cases, the series of acts 1100 includes an act of generating one or more interactive object elements based on previous interactions with one or more previous interactive object elements generated utilizing the diffusion model.

In one or more embodiments, the series of acts 1100 includes an act of generating the one or more interactive elements by providing, to the diffusion model, a reference image comprising a style, a layout, or a composition for the one or more interactive object elements. Additionally, the series of acts 1100 includes an act of generating the one or more interactive object elements in the style, the layout, or the composition of the reference image.

### Architecture: Pixel Diffusion

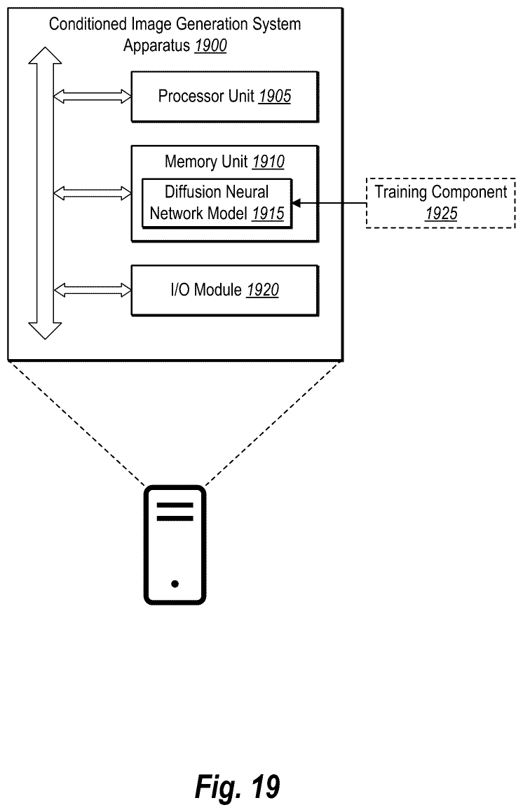

FIG. 12 shows an example of a guided diffusion model 1200 according to aspects of the present disclosure. In some examples, guided diffusion model 1200 describes the operation and architecture of the diffusion neural network model 1915 described with reference to FIG. 19. The guided diffusion model 1200 depicted in FIG. 12 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1200 may take an original media item 1205 in a pixel space 1210 as input and apply forward diffusion process 1215 to gradually add noise to the original media item 1205 to obtain noisy media item 1220 at various noise levels.

Next, a reverse diffusion process 1225 (e.g., a U-Net) gradually removes the noise from the noisy media item 1220 at the various noise levels to obtain an output media item 1230. In some cases, an output media item 1230 is created from each of the various noise levels. The output media item 1230 can be compared to the original media item 1205 to train the reverse diffusion process 1225.

The reverse diffusion process 1225 can also be guided based on a text prompt 1235, or another guidance prompt, such as an image, a layout, a segmentation map, etc. The text prompt 1235 can be encoded using a text encoder 1240 (e.g., a multimodal encoder) to obtain guidance features 1245 in guidance space 1250. The guidance features 1245 can be combined with the noisy media item 1220 at one or more layers of the reverse diffusion process 1225 to ensure that the output media item 1230 includes content described by the text prompt 1235. For example, guidance features 1245 can be combined with the noisy features using a cross-attention block within the reverse diffusion process 1225.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

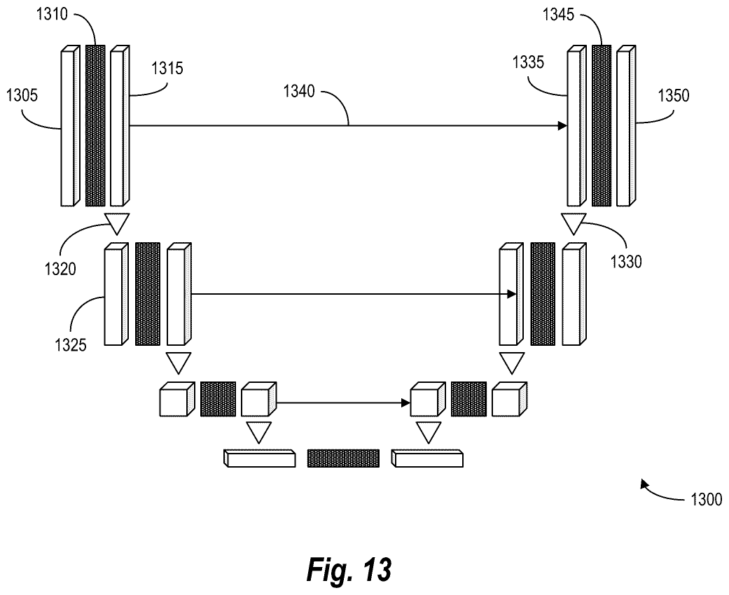

FIG. 13 shows an example of a U-Net 1300 according to aspects of the present disclosure. In some examples, U-Net 1300 is an example of the component that performs the reverse diffusion process 1225 of guided diffusion model 1200 described with reference to FIG. 12 and includes architectural elements of the diffusion neural network model 1915 described with reference to FIG. 19. The U-Net 1300 depicted in FIG. 13 is an example of, or includes aspects of, the architecture used within the reverse diffusion process described with reference to FIG. 11.

In some examples, diffusion models are based on a neural network architecture known as a U-Net. The U-Net 1300 takes input features 1305 having an initial resolution and an initial number of channels and processes the input features 1305 using an initial neural network layer 1310 (e.g., a convolutional network layer) to produce intermediate features 1315. The intermediate features 1315 are then down-sampled using a down-sampling layer 1320 such that down-sampled features 1325 have a resolution less than the initial resolution and a number of channels greater than the initial number of channels.

This process is repeated multiple times, and then the process is reversed. That is, the down-sampled features 1325 are up-sampled using up-sampling process 1330 to obtain up-sampled features 1335. The up-sampled features 1335 can be combined with intermediate features 1315 having the same resolution and number of channels via a skip connection 1340. These inputs are processed using a final neural network layer 1345 to produce output features 1350. In some cases, the output features 1350 have the same resolution as the initial resolution and the same number of channels as the initial number of channels.

In some cases, U-Net 1300 takes additional input features to produce conditionally generated output. For example, the additional input features could include a vector representation of an input prompt. The additional input features can be combined with the intermediate features 1315 within the neural network at one or more layers. For example, a cross-attention module can be used to combine the additional input features and the intermediate features 1315.

### Inference: Conditional Generation

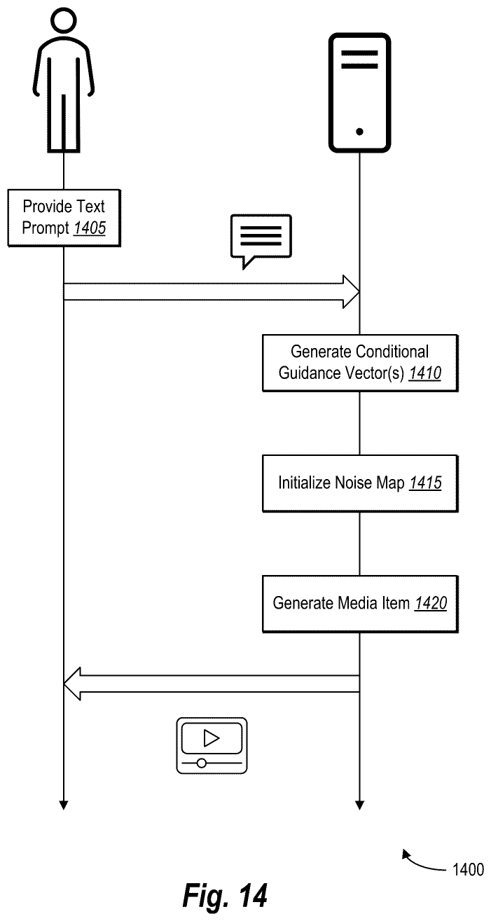

FIG. 14 shows an example of a method 1400 for conditional media generation according to aspects of the present disclosure. In some examples, method 1400 describes an operation of the diffusion neural network model 1915 described with reference to FIG. 19 such as an application of the guided diffusion model 1200 described with reference to FIG. 12. In some examples, these operations are performed by a system including a processor executing a set of codes to control functional elements of an apparatus such as the media generation model described in FIG. 12.

Additionally or alternatively, steps of the method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, a user provides a text prompt describing content to be included in a generated media item. For example, a user may provide the prompt “a person playing with a cat”. In some examples, guidance can be provided in a form other than text, such as via an image, a sketch, or a layout.

At operation 1410, the system converts the text prompt (or other guidance) into a conditional guidance vector or other multi-dimensional representation. For example, text may be converted into a vector or a series of vectors using a transformer model, or a multi-modal encoder.

In some cases, the encoder for the conditional guidance is trained independently of the diffusion model.

At operation 1415, a noise map is initialized that includes random noise. The noise map may be in a pixel space or a latent space. By initializing a media item with random noise, different variations of a media item including the content described by the conditional guidance can be generated.

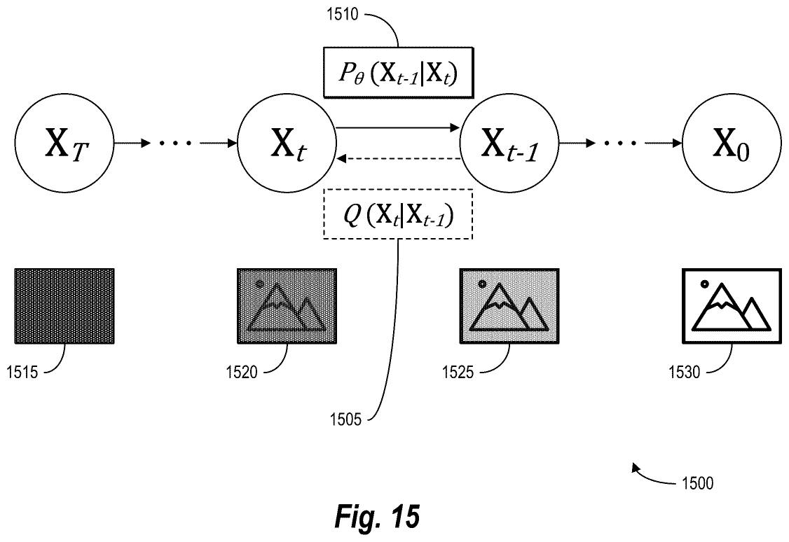

At operation 1420, the system generates a media item based on the noise map and the conditional guidance vector. For example, the media item may be generated using a reverse diffusion process as described with reference to FIG. 15.

### Inference: Reverse Diffusion

FIG. 15 shows a diffusion process 1500 according to aspects of the present disclosure. In some examples, diffusion process 1500 describes an operation of the diffusion neural network model 1915 described with reference to FIG. 19, such as the reverse diffusion process 1225 of guided diffusion model 1200 described with reference to FIG. 12.

As described above with reference to FIG. 12, using a diffusion model can involve both a forward diffusion process 1505 for adding noise to a media item (or features in a latent space) and a reverse diffusion process 1510 for denoising the media item (or features) to obtain a denoised media item. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate media items with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy media item 1515 and denoises the data to obtain the p(xₜ₋₁|xₜ). At each step t−1, the reverse diffusion process 1510 takes xₜ, such as first intermediate media item 1520, and t as input. Here, t represents a step in the sequence of transitions associated with different noise levels, The reverse diffusion process 1510 outputs xₜ₋₁, such as second intermediate media item 1525 iteratively until x₇ reverts back to x₀, the original media item 1530. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

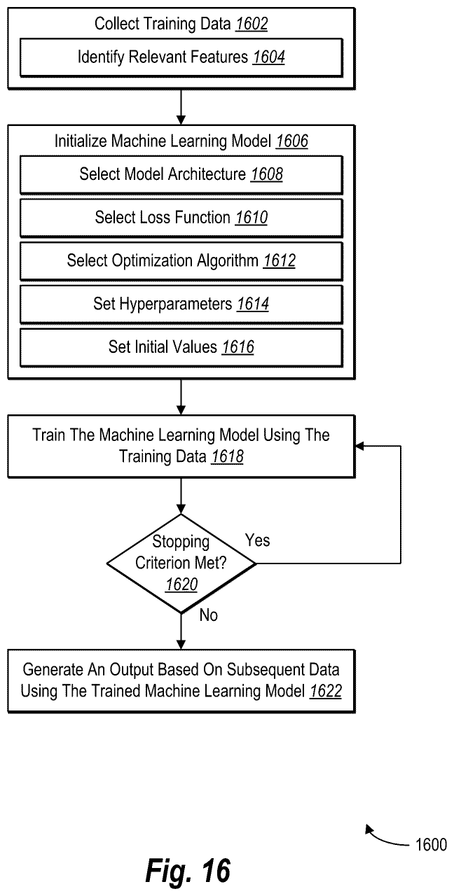

FIG. 16 is a flow diagram depicting an algorithm as a step-by-step procedure 1600 in an example implementation of operations performable for training a machine-learning model. In some embodiments, the step-by-step procedure 1600 describes an operation of the training component 1925 described for configuring the diffusion neural network model 1915 as described with reference to FIG. 19. The step-by-step procedure 1600 provides one or more examples of generating training data, use of the training data to train a machine-learning model, and use of the trained machine-learning model to perform a task.

To begin in this example, a machine-learning system collects training data (block 1602) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine-learning model (i.e., predictions) and target values (e.g., as expressed by the training data) to be used to train the machine-learning model. Additionally, an optimization algorithm is selected (block 1612) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1616) examples of which includes initializing weights and biases of nodes to improve efficiency in training and computational resources consumption as part of training. Hyperparameters are also set (block 1614) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the step-by-step procedure 1600 continues training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore once trained is configured to perform that task based on subsequent data received as an input and processed by the machine-learning model.

### Training: Diffusion Training

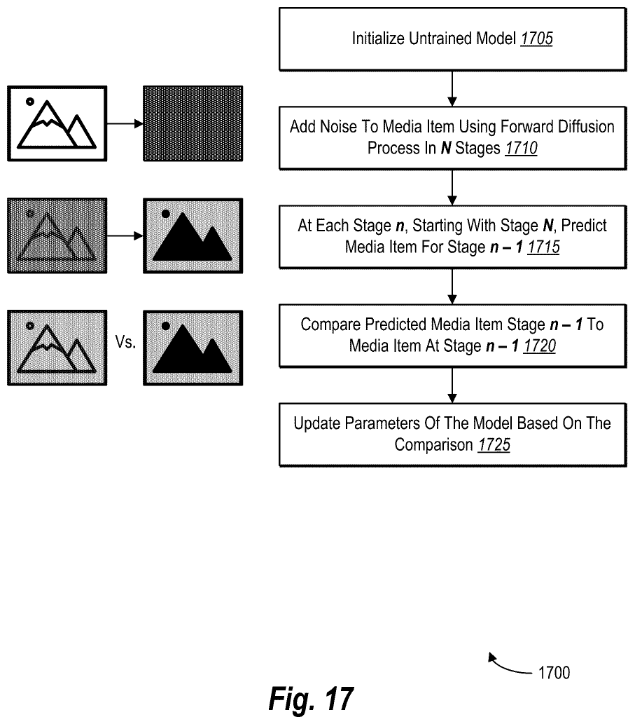

FIG. 17 shows an example of a method 1700 for training a diffusion model according to aspects of the present disclosure. In some embodiments, the method 1700 describes an operation of the training component 1925 described for configuring the diffusion neural network model 1915 as described with reference to FIG. 19. The method 1700 represents an example for training a reverse diffusion process as described above with reference to FIG. 15. In some examples, these operations are performed by a system including a processor executing a set of codes to control functional elements of an apparatus, such as the guided diffusion model described in FIG. 12.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1715, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1725, the system updates parameters of the model based on the comparison. For example, parameters of a U-Net may be updated using gradient descent. Time-dependent parameters of the Gaussian transitions can also be learned.

### System: Computing Device

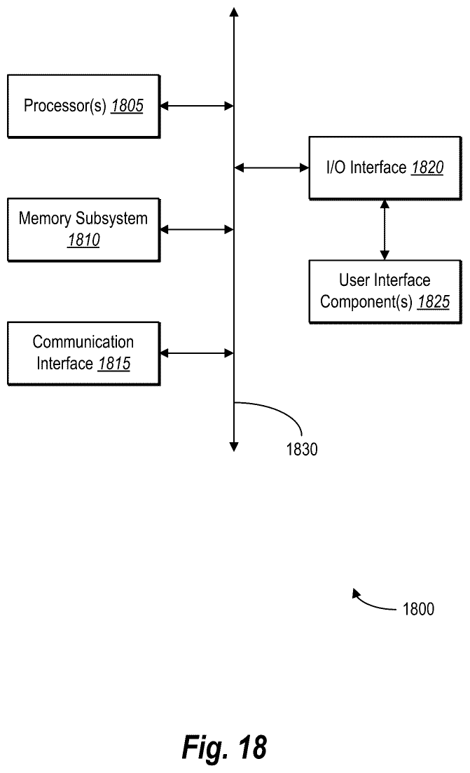

FIG. 18 shows an example of a computing device 1800 according to aspects of the present disclosure. The computing device 1800 may be an example of the synthesized image generation apparatus 1900 described with reference to FIG. 19. In one aspect, computing device 1800 includes one or more processors 1805, memory subsystem 1810, communication interface 1815, I/O interface 1820, user interface component(s) 1825, and channel 1830.

In some embodiments, computing device 1800 is an example of, or includes aspects of, the media generation model of FIG. 12. In some embodiments, computing device 1800 includes one or more processors 1805 that can execute instructions stored in memory subsystem 1810 to perform media generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface component(s) 1825 enable a user to interact with computing device 1800. In some cases, user interface component(s) 1825 include an audio device, such as an external speaker system, an external display device such as a display screen, an input device (e.g., a remote-control device interfaced with a user interface directly or through the I/O controller), or a combination thereof. In some cases, user interface component(s) 1825 include a GUI.

### System: Synthesized Image Generation Apparatus

FIG. 19 shows an example of a synthesized image generation apparatus 1900 according to aspects of the present disclosure. Synthesized image generation apparatus 1900 may include an example of, or aspects of, the guided diffusion model described with reference to FIG. 12 and the U-Net described with reference to FIG. 13. In some embodiments, synthesized image generation apparatus 1900 includes processor unit 1905, memory unit 1910, diffusion neural network model 1915, I/O module 1920, and training component 1925. Training component 1925 updates parameters of the diffusion neural network model 1915 stored in memory unit 1910. In some examples, the training component 1925 is located outside the synthesized image generation apparatus 1900.

Processor unit 1905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1905 is configured to operate a memory array using a memory controller. In other cases, a memory controller is integrated into processor unit 1905. In some cases, processor unit 1905 is configured to execute computer-readable instructions stored in memory unit 1910 to perform various functions. In some aspects, processor unit 1905 includes special purpose components for modem processing, baseband processing, digital signal processing, or transmission processing. According to some aspects, processor unit 1905 comprises one or more processors described with reference to FIG. 18.

Memory unit 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1905 to perform various functions described herein.

In some cases, memory unit 1910 includes a basic input/output system (BIOS) that controls basic hardware or software operations, such as an interaction with peripheral components or devices. In some cases, memory unit 1910 includes a memory controller that operates memory cells of memory unit 1910. For example, the memory controller may include a row decoder, column decoder, or both. In some cases, memory cells within memory unit 1910 store information in the form of a logical state. According to some aspects, memory unit 1910 is an example of the memory subsystem 1810 described with reference to FIG. 18.

According to some aspects, synthesized image generation apparatus 1900 uses one or more processors of processor unit 1905 to execute instructions stored in memory unit 1910 to perform functions described herein. For example, the synthesized image generation apparatus 1900 may generate synthesized digital images based on one or more reference digital images and a text prompt.

The memory unit 1910 may include a diffusion neural network model 1915 trained to generate synthesized digital images based on a composite embedding. For example, after training, the diffusion neural network model 1915 may perform inferencing operations as described with reference to FIGS. 13 and 14 to generate synthesized digital images based on a composite embedding.

In some embodiments, the diffusion neural network model 1915 is an Artificial neural network (ANN) such as the guided diffusion model described with reference to FIG. 12 and the U-Net described with reference to FIG. 13. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion neural network model 1915 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1925 may train the diffusion neural network model 1915. For example, parameters of the diffusion neural network model 1915 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 15 and 16). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion neural network model 1915 can be used to make predictions on new, unseen data (i.e., during inference).

I/O module 1920 receives inputs from and transmits outputs of the synthesized image generation apparatus 1900 to other devices or users. For example, I/O module 1920 receives inputs for the diffusion neural network model 1915 and transmits outputs of the diffusion neural network model 1915. According to some aspects, I/O module 1920 is an example of the I/O interface 1820 described with reference to FIG. 18.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

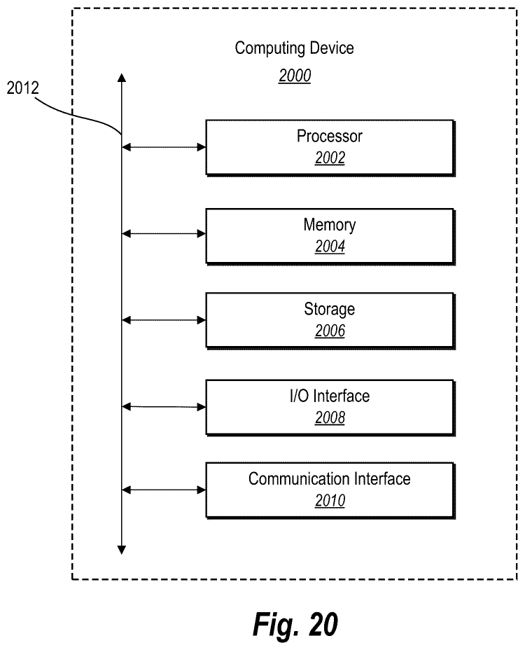

FIG. 20 illustrates, in block diagram form, an example computing device 2000 (e.g., the computing device 2000, the client device 110, and/or the server device(s) 104) that may be configured to perform one or more of the processes described above. As shown by FIG. 20, the computing device can comprise a processor(s) 2002, memory 2004, a storage device 2006, an I/O interface 2008, and a communication interface 2010.

In particular embodiments, processor(s) 2002 includes hardware for executing instructions, such as those making up a computer program. As an example, and not by way of limitation, to execute instructions, processor(s) 2002 may retrieve (or fetch) the instructions from an internal register, an internal cache, memory 2004, or a storage device 2006 and decode and execute them. The computing device 2000 includes memory 2004, which is coupled to the processor(s) 2002. The memory 2004 may be used for storing data, metadata, and programs for execution by the processor(s). The memory 2004 may include one or more of volatile and non-volatile memories. The memory 2004 may be internal or distributed memory. The computing device 2000 includes a storage device 2006 includes storage for storing data or instructions. As an example, and not by way of limitation, storage device 2006 can comprise a non-transitory storage medium described above. The computing device 2000 also includes one or more input or output (“I/O”) devices/interfaces 2008, which are provided to allow a user to provide input to (such as user strokes), receive output from, and otherwise transfer data to and from the computing device 2000. These I/O devices/interfaces 2008 may include a mouse, keypad or a keyboard, a touch screen, camera, optical scanner, network interface, modem, other known I/O devices or a combination of such I/O devices/interfaces 2008.

The computing device 2000 can further include a communication interface 2010. The communication interface 2010 can include hardware, software, or both. The communication interface 2010 can provide one or more interfaces for communication (such as, for example, packet-based communication) between the computing device and one or more other computing devices (e.g., computing device 2000) or one or more networks. The computing device 2000 can further include a bus 2012. The bus 2012 can comprise hardware, software, or both that couples components of computing device 2000 to each other.

What is claimed is:

1. A computer-implemented method comprising:
determining, by at least one processor and from a text input via a graphical user interface, a theme for inserting image content into a digital image within the graphical user interface;
generating, by the at least one processor in response to the text input, a prompt indicating one or more objects related to the theme;
generating, by the at least one processor utilizing an image generation neural network according to the prompt, one or more object elements corresponding to the one or more objects related to the theme for display within the graphical user interface; and
providing, by the at least one processor and for display in the graphical user interface, the one or more object elements as one or more interactive object elements for inserting into the digital image.

2. The computer-implemented method of claim 1, wherein generating the one or more object elements comprises:
providing a reference image to the image generation neural network comprising a style, a layout, or a composition for the one or more object elements; and
generating the one or more object elements in the style, the layout, or the composition of the reference image.

3. The computer-implemented method of claim 1, wherein generating the one or more object elements comprises providing a reference image to the image generation neural network that causes image generation neural network to generate the one or more object elements in a spatial arrangement based on the reference image.

4. The computer-implemented method of claim 3, wherein generating the one or more object elements further comprises generating the one or more object elements in a spatial arrangement that is based on a plurality of visually distinct regions of the reference image, causing the one or more object elements to be positioned according to the plurality of visually distinct regions.

5. The computer-implemented method of claim 1, further comprising:
generating the prompt indicating one or more objects related to the theme to include one or more key words that cause the image generation neural network to generate an intermediate digital image including the one or more object elements with visually distinct object boundaries; and
generating, from the intermediate digital image including the one or more object elements, the one or more interactive object elements for display in the graphical user interface by segmenting the one or more object elements according to the visually distinct object boundaries.

6. The computer-implemented method of claim 5, wherein generating the one or more interactive object elements further comprises:
determining, from the intermediate digital image and utilizing a segmentation neural network, one or more object masks according to the one or more object elements with visually distinct object boundaries; and
generating, utilizing the one or more object masks, the one or more interactive object elements by cropping the one or more object elements from the intermediate digital image.

7. A system comprising:
a memory component; and
one or more processing devices coupled to the memory component, the one or more processing devices to perform operations comprising:
determining, from a text input via a graphical user interface, a theme for inserting image content into a digital image within the graphical user interface;
generating a first prompt comprising the theme to cause a large language model to generate a list of objects related to the theme;
generating a second prompt comprising the list of objects related to the theme to cause a diffusion model to generate one or more object elements corresponding to the list of objects; and
providing, for display in the graphical user interface, the one or more object elements as one or more interactive object elements for inserting into the digital image.

8. The system of claim 7, wherein generating the first prompt comprises generating, in response to determining the theme from the text input via the graphical user interface, instructions for a large language model to generate text including a list of distinct objects representative of the theme.

9. The system of claim 7, wherein generating the second prompt comprising the list of objects related to the theme to cause the diffusion model to generate the one or more object elements corresponding to the list of objects comprises:
generating instructions for the diffusion model to generate an intermediate digital image comprising the one or more object elements based on the list of objects related to the theme; and
generating, from the intermediate digital image, the one or more interactive object elements for inserting into the digital image.

10. The system of claim 9, wherein generating the one or more interactive object elements further comprises:
segmenting each object element of the one or more object elements of the intermediate digital image utilizing a segmentation neural network; and
generating the one or more interactive object elements by generating one or more separate digital images including the one or more object elements in response to segmenting each object element utilizing the segmentation neural network.

11. The system of claim 10, wherein generating the one or more interactive object elements further comprises:
generating one or more masks representing the one or more object elements of the intermediate digital image utilizing the segmentation neural network; and
generating the one or more separate digital images from the one or more masks representing the one or more object elements.

12. The system of claim 7, wherein generating the first prompt further comprises generating, in response to determining the theme from the text input, the first prompt with instructions to generate a plurality of distinct, physical objects in a comma-separated list.

13. The system of claim 7, wherein generating the second prompt further comprises:
providing, to the diffusion model with the second prompt, a reference image including regions with visually distinct boundaries; and
providing, to the diffusion model, a text prompt to generate an intermediate digital image based on the list of objects related to the theme according to the reference image.

14. The system of claim 7, wherein providing the one or more object elements as the one or more interactive object elements comprises:
generating, for display in the graphical user interface, a plurality of selectable digital images including the one or more object elements; and
providing, for display in the graphical user interface, the plurality of selectable digital images including the one or more object elements as the one or more interactive object elements for inserting into the digital image.

15. A non-transitory computer-readable medium storing instructions which, when executed by a processing device, cause the processing device to perform operations comprising:
determining, from a text input via a graphical user interface, a theme for inserting image content into a digital image within the graphical user interface;
generating, in response to the text input, a prompt indicating one or more objects related to the theme;
generating, by utilizing a diffusion model according to the prompt, one or more object elements corresponding to the one or more objects related to the theme for display within the graphical user interface; and
providing, for display in the graphical user interface, the one or more object elements as one or more interactive object elements for inserting into the digital image.

16. The non-transitory computer-readable medium of claim 15, further comprising:
generating an additional prompt comprising instructions to cause a large language model to generate text including a list of objects related to the theme; and
generating the prompt indicating the one or more objects related to the theme from the list of objects generated by the large language model.

17. The non-transitory computer-readable medium of claim 15, further comprising auto-populating the one or more interactive object elements into the digital image within the graphical user interface.

18. The non-transitory computer-readable medium of claim 15, wherein generating one or more interactive object elements comprises:
generating the prompt indicating one or more objects related to the theme comprising one or more key words that cause the diffusion model to generate an intermediate digital image including the one or more object elements with visually distinct object boundaries according to visually distinct regions in a reference image; and
generating, from the intermediate digital image including the one or more object elements, the one or more interactive object elements for display in the graphical user interface.

19. The non-transitory computer-readable medium of claim 15, further comprising generating one or more interactive object elements based on previous interactions with one or more previous interactive object elements generated utilizing the diffusion model.

20. The non-transitory computer-readable medium of claim 15, wherein generating the one or more interactive object elements comprises:
providing, to the diffusion model, a reference image comprising a style, a layout, or a composition for the one or more interactive object elements; and
generating the one or more interactive object elements in the style, the layout, or the composition of the reference image.
